(19) United States
(12) Patent Application Publication
(10) Pub. No.: US 2007/0010695 A1
(43) Pub. Date: Jan. 11, 2007

(54) Diphosphines, preparation and uses thereof

(76) Inventors: Marc Lemaire, Villeurbanne (FR); Christine Saluzzo, Le Manz (FR); Mikael Berthod, Lyon (FR)

Correspondence Address: RHODIA INC., 259 PROSPECT PLAINS ROAD, CN 7500, CRANBURY, NJ, 08512, US

(21) Appl. No.: 10/539,640

(22) PCT Filed: Dec. 17, 2003
(86) PCT No.: PCT/FR03/03782

§ 371 Date: Sep. 21, 2006

(30) Foreign Application Priority Data
Dec. 18, 2002 (FR) 0216086
Apr. 9, 2003 (FR) 0304392
Apr. 29, 2003 (FR) 0305255

(51) Int. Cl. C07F 9/28; C08F 20/00

(52) U.S. Cl. 564/420; 568/9; 564/15; 525/440

(57) ABSTRACT

The invention concerns novel diphosphines of formula (I) useful in particular, in their optically active form, as ligands in metal complexes. The invention also concerns their uses an intermediates in the preparation of polymeric insoluble ligands. The invention further concerns the use of said insoluble ligands in the preparation of metal complexes for asymmetric. catalysis.

The present invention relates to novel diphosphines especially in their optically active form, and also to the process for obtaining them.

The invention is also directed toward their uses as bidentate ligands in the synthesis of transition metal-based catalysts for asymmetric catalysis.

The invention is also directed toward their uses as intermediate products in the preparation of ligands in insoluble form. More particularly, the invention lies in an optically active polymer in which one of the polymer units consists of a chiral diphosphine.

The invention is also directed toward the use of said polymer as a ligand in the preparation of metal complexes for asymmetric catalysis.

The production of pure optically active compounds is a problem that arises in many technical fields, for instance pharmacy, agrochemistry, the food industry (food additives and flavorings) and also in the fragrance industry.

This problem is expected to become increasingly important since it has been found more and more that, in a given application, only one of the stereoisomers has the desired property.

Asymmetric catalysis has undergone considerable expansion in recent years. It has the advantage of leading directly to the preparation of optically pure or optically enriched isomers by asymmetric induction without it being necessary to perform resolution of racemic mixtures.

2,2′-Bis(diphenylphosphino)-1,1′-binaphthyl (BINAP) is an example of a diphosphorus ligand commonly used for the preparation of metal complexes for the asymmetric catalysis of hydrogenation, carbonylation, hydrosilylation and C—C bond forming reactions (such as allylic substitutions or Grignard cross-couplings) or even asymmetric isomerization reactions of allylamines.

The complexes used are derivatives of palladium, ruthenium, rhodium and iridium salts.

The development of novel chiral ligands is desirable for several reasons.

Ligands that are capable of improving the enantio-selectivity of reactions are sought.

There is also a need for ligands that are industrially readily accessible.

Thus, document WO 00/49028 describes a diphosphine that is a BINAP derivative, the two naphthyl groups of which bear a substitution in position 6 and 6′. The agent more specifically concerned is 6,6′-diaminomethylBINAP.

However, the preparation of this phosphine is not readily achievable industrially, since it includes numerous steps:

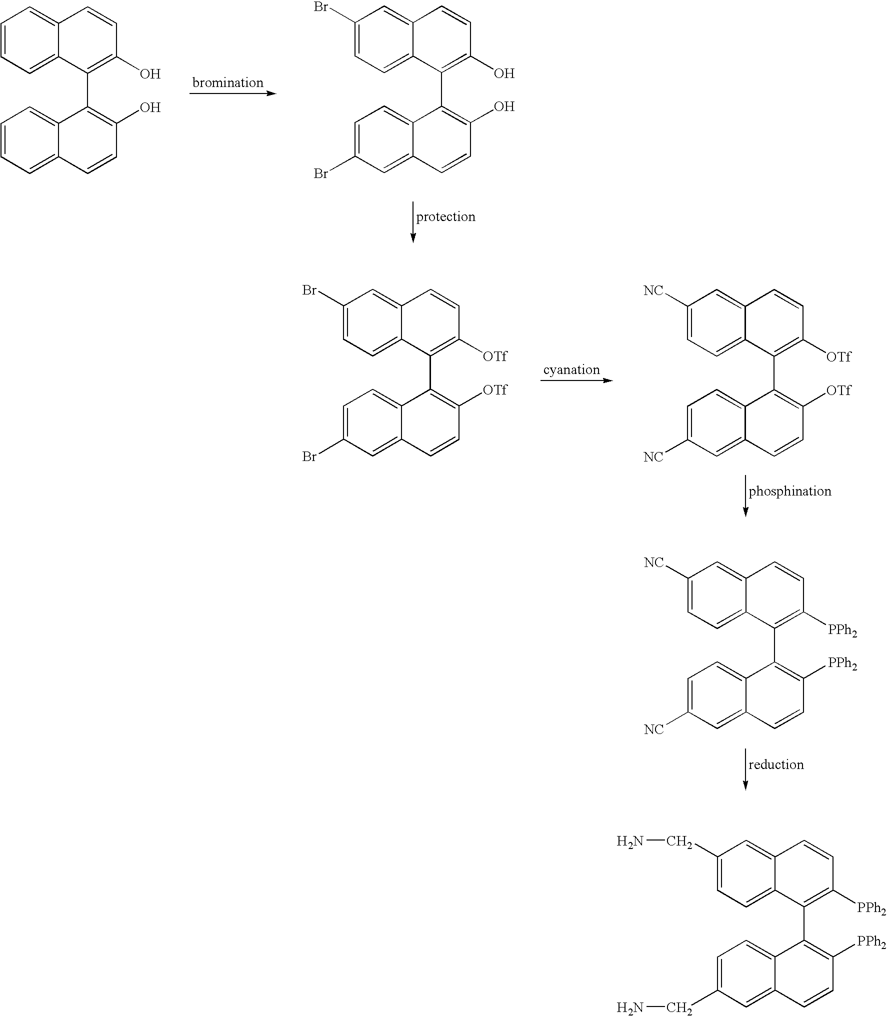

In the pursuit of its research, the Applicant has found that it is possible to prepare diphosphines that may be prepared much more readily on an industrial scale since they are derived from a commercial product, namely 2,2′-bis(diphenylphosphino)-1,1′-binaphthyl or BINAP.

A first subject of the invention is diphosphines in which the naphthyl groups are substituted in the 5,5′ position.

Another subject of the invention is intermediate products that are diphosphines in dioxide form containing substituents in the 5,5′ position.

The invention is directed not only toward the racemic mixture but also toward the optically active forms of said diphosphines.

Other subjects of the invention are the processes for preparing said disphosphines, and the uses thereof in asymmetric catalysis.

The present invention thus provides a diphosphine that may be used as ligands in chiral catalysts, and corresponding to formula (I): 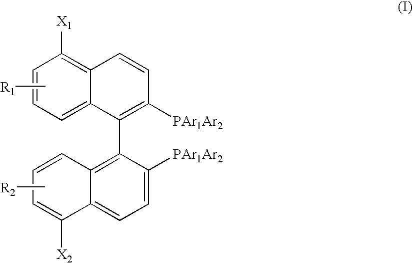
in said formula:
   R₁ and R₂, which may be identical or different, represent a hydrogen atom or a substituent,
   Ar₁ and Ar₂ independently represent an alkyl, alkenyl, cycloalkyl, aryl or arylalkyl group,
   X₁ and X₂, which may be identical or different, represent:
      a group R, alkyl, alkenyl, alkynyl, cycloalkyl, aryl or arylalkyl,
      an alkyl group substituted with one or more halogen atoms, preferably fluorine, or with nitro or amino groups,
      a halogen atom chosen from bromine, chlorine and iodine,
      an —OH group,
      a group —ORₐ,
      a group —O—CORₐ,
      a group —S—Rₐ,
      a —CN group,
      a group derived from the nitrile group such as:
         a —CH₂—NH₂ group,
         a —COOH group,
      a group derived from the carboxylic group such as:
         a group —COORₐ,
         a —CH₂OH group,
         a group —CO—NH—R_{b},
      a group derived from the aminomethyl group such as:
         a group —CH₂—NH—CO—R_{b},
         a group —CH₂—NH—CO—NH—R_{b},
         a group —CH₂—N═CH—Rₐ,
         a —CH₂—N═C═O group,
         a —CH₂—NH₄⁺ group,
      a group comprising a nitrogen atom such as:
         a group —NHRₐ,
         a group —N(Rₐ)₂,
         a group —N═CH—Rₐ,
         an —NH—NH₂ group,
         an —N═N⁺═N⁻ group,
         an —N═C═O group,
      a magnesium or lithium atom,
   in the various formulae, Rₐ represents an alkyl, cycloalkyl, arylalkyl or phenyl group and R_{b} has the meaning given for Rₐ and also represents a naphthyl group.

The present invention is also directed toward the intermediate products, i.e. the diphosphine in dioxide form, in racemic form or in chiral form, and which corresponds to the following formula: 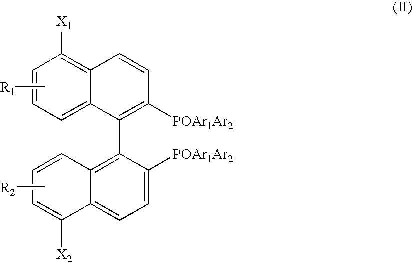
in said formula (II), R₁, R₂, Ar₁, Ar₂, X₁ and X₂ have the meaning given for formula (I).

Among the diphosphines corresponding to the general formula (I), one particularly advantageous group of diphosphines is that consisting of the diphosphines corresponding to formula (I′), which may be used as intermediate products for the preparation of insoluble polymers as constituents of one of the polymer units: 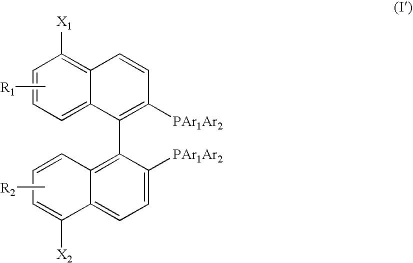
in said formula:
   R₁ and R₂, which may be identical or different, represent a hydrogen atom or a substituent,
   Ar₁ and Ar₂ independently represent an alkyl, alkenyl, cycloalkyl, aryl or arylalkyl group,
   X₁ and X₂, which are identical, represent:
      an —OH group,
      a —CH₂OH group,
      a —CH₂—NH₂,
      a —COOH group,
      a group —COORₐ in which Rₐ represents an alkyl, cycloalkyl, arylalkyl or phenyl group,
      an —N═C═O group,
      a —CH₂—N═C═O group.

The characteristic of the diphosphines of formula (I′) is that they bear two functional groups capable of reacting with one or more polymerizable monomers leading to a polymer which, when it is obtained from a chiral diphosphine, is optically active and is thus able to be used as a ligand in metal complexes used in asymmetric catalysis.

The definition of certain terms used in the present text is recalled hereinbelow.

The term “chiral” refers to a molecular species that is not superposable on its mirror image.

A compound is racemic if it is the equimolar mixture of its two enantiomeric forms. The term “enantiomers” denotes molecular species that are mirror images of each other and that are not superposable.

A compound is optically active if it is capable of rotating the plane of polarization of a transmitted beam of plane polarized light. An optically active compound is necessarily chiral.

In the context of the invention, the term “alkyl” means a linear or branched hydrocarbon-based chain containing from 1 to 15 carbon atoms and preferably 1 or 2 to 10 carbon atoms.

Examples of preferred alkyl groups are especially methyl, ethyl, propyl, isopropyl, butyl, isobutyl and t-butyl.

The term “alkenyl” means a linear or branched hydrocarbon-based group containing from 2 to 15 carbon atoms, comprising one or more double bonds and preferably one or two double bonds.

The term “alkynyl” means a linear or branched hydrocarbon-based group containing from 2 to 15 carbon atoms, comprising one or more triple bonds and preferably one-triple bond.

The term “cycloalkyl” means a cyclic hydrocarbon-based group, which is monocyclic comprising from 3 to 8 carbon atoms, preferably a cyclopentyl or cyclohexyl group, or polycyclic (bicyclic or tricyclic) comprising from 4 to 18 carbon atoms, especially adamantyl or norbornyl.

The term “aryl” means a monocyclic or polycyclic, preferably monocyclic or bicyclic, aromatic group comprising from 6 to 20 carbon atoms, preferably phenyl or naphthyl. When the group is polycyclic, i.e. when it comprises more than one cyclic nucleus, the cyclic nuclei may be fused in pairs or attached in pairs via a bonds.

Examples of (C₆-C₁₈)aryl groups are especially phenyl, naphthyl, anthryl and phenanthryl.

The term “arylalkyl” means a linear or branched hydrocarbon-based group bearing a monocyclic aromatic ring and comprising from 7 to 12 carbon atoms, preferably benzyl.

In formula (I), (I′) or (II), the carbocyclic groups Ar₁ and Ar₂ may bear substituents which are such that they do not interfere with the complexation of the ligand to the metal during the preparation of the catalyst.

Examples of substituents are alkyl, alkoxy, thioalkoxy, alkoxyalkyl, thioalkoxyalkyl, polyoxyalkylene, —SO₃H, —SO₃M in which M is an ammonium or metal cation, —PO₃H₂, —PO₃HM or —PO₃M₂ groups in which M is as defined above.

Preferably, M is an alkali metal cation such as Na, Li or K.

It is desirable for the substituents not to interfere with the reactions performed in the preparation of the compounds (I) and (I′) starting with the precursors from which they are derived. However, protection and deprotection steps may be envisioned, where appropriate. A person skilled in the art may refer to the following publication Protective Groups in Organic Synthesis, Greene T. W. and Wuts P. G. M., published by John Wiley and Sons, 1991, to perform the protection of particular organic functions.

In the alkyl, alkoxy, thioalkoxy, alkoxyalkyl and thioalkoxyalkyl groups, the alkyl portions are linear or branched saturated hydrocarbon-based groups comprising especially up to 25 carbon atoms, for example from 1 to 12 carbon atoms and better still from 1 to 6 carbon atoms.

Examples of alkyl groups are methyl, ethyl, propyl, isopropyl, butyl, isobutyl, t-butyl, pentyl, isopentyl, neopentyl, 2-methylbutyl, 1-ethylpropyl, hexyl, isohexyl, neohexyl, 1-methylpentyl, 3-methylpentyl, 1,1-dimethylbutyl, 1,3-dimethylbutyl, 2-ethylbutyl, 1-methyl-1-ethylpropyl, heptyl, 1-methylhexyl, 1-propylbutyl, 4,4-dimethylpentyl, octyl, 1-methylheptyl, 2-ethylhexyl, 5,5-dimethylhexyl, nonyl, decyl, 1-methylnonyl, 3,7-dimethyloctyl and 7,7-dimethyloctyl groups.

Preferably, the substituents are alkyl or alkoxy groups preferably containing from 1 to 6 carbon atoms.

In accordance with the present invention, the preferred ligands and the intermediates thereof correspond, respectively, to formula (I), (I′) or (II) in which Ar₁ and Ar₂ independently represent a (C₁-C₆)alkyl group; a phenyl group optionally substituted with one or more (C₁-C₆)alkyl or (C₁-C₆)alkoxy groups; or a (C₄-C₈)cycloalkyl group optionally substituted with one or more (C₁-C₆)alkyl groups.

Among the preferred compounds of formula (I), (I′) or (II) are those for which Ar₁ and Ar₂ are, independently, a (C₁-C₄)alkyl group; a phenyl group optionally substituted with methyl or tert-butyl; or a (C₅-C₆)cycloalkyl group optionally substituted with methyl or tert-butyl.

The compounds of formula (I), (I′) or (II) in which Ar₁ and Ar₂ are identical and preferably represent a phenyl group are most particularly preferred.

The carbocyclic groups Ar₁ and Ar₂ may bear substituents which are such that they do not interfere with the reactions used in the process of the invention. These substituents are inert under the conditions used in the halogenation (step i), cyanation (step ii) and reduction (steps iii and iv) reactions. Thus, the invention does not exclude the presence of substituents other than R₁ and R₂.

The naphthyl groups may also bear a substituent represented by R₁ or R₂, which may be of the same nature as those that have just been mentioned.

Preferably, the substituents are alkyl or alkoxy groups preferably containing from 1 to 6 carbon atoms.

In formulae (I), (I′) and (II), R₁ and R₂ preferably represent a hydrogen atom or one or more groups chosen from (C₁-C₄)alkyl and (C₁-C₄)alkoxy.

The preferred compounds (I), (I′) and (II) do not bear a substituent, which means that R₁ and R₂ represent a hydrogen atom.

As regards the preferred groups X₁ and X₂, Rₐ represents an alkyl group containing from 1 to 4 carbon atoms, a cyclohexyl group, a phenyl group and a benzyl group, and R_{b} has the meaning given for Rₐ and also represents a naphthyl group.

The preferred functional groups located in position 5 and 5′ in the compounds of formulae (I), (I′) and (II) are the following:
a halogen atom, preferably a bromine or chlorine atom,
an alkyl group substituted with one or more fluorine atoms,
a —CN group,
a —CH₂—NH₂ group,
a —COOH group.

Among the compounds of formula (I) that are especially distinguished are the compounds having the following formula: 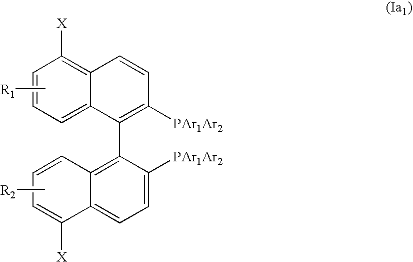
in said formula:
   X represents a chlorine, bromine or iodine atom,
   R₁, R₂, Ar₁ and Ar₂ have the meaning given above.

A first subject of the invention lies in a process for preparing the diphosphine of formula (Ia₁), characterized in that it comprises the following steps:

i) performing the halogenation in the 5,5′ position of a compound of formula (III): 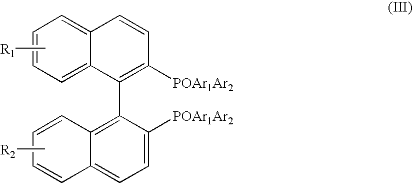
in said formula:
   R₁, R₂, Ar₁ and Ar₂ have the meaning given above,
      using a halogen and in the presence of iron, so as to obtain the corresponding dihalo compound of formula: 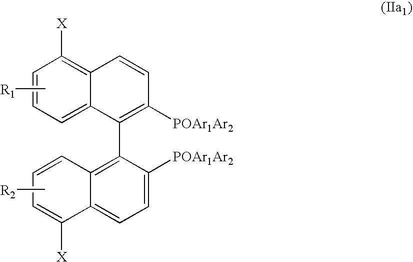
in said formula:
   X represents a chlorine, bromine or iodine atom,
   R₁, R₂, Ar₁ and Ar₂ have the meaning given above;

ii) performing the reduction of the diphosphine in dioxide and dihalo form in position 5,5′ of formula (IIa₁), into the diphosphine of formula (Ia₁): 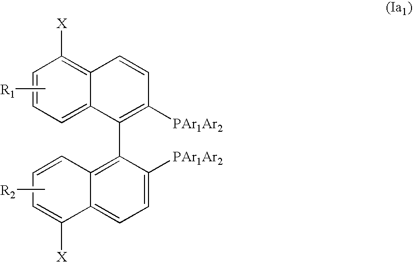
in said formula:
   X represents a chlorine, bromine or iodine atom,
   R₁, R₂, Ar₁ and Ar₂ have the meaning given above.

The diphosphine in dioxide form of formula (III) is known. It may be obtained by oxidation of the diphosphine of formula (IV): 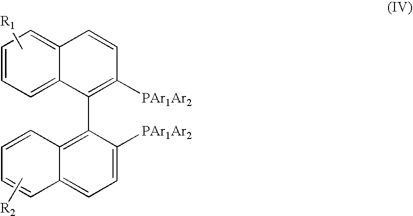
in said formula:
   R₁, R₂, Ar₁ and Ar₂ have the meaning given above.

The diphosphine in oxide form of formula (III) is obtained by oxidation using an agent for oxidizing the diphosphine of formula (IV).

Although any type of oxidizing agent may be used, a chemical oxidizing agent, for example potassium permanganate or alternatively molecular oxygen or a gas containing it, use is preferably made of hydrogen peroxide, preferably in the form of an aqueous solution.

The concentration of the hydrogen peroxide solution is advantageously between 10% and 35% by weight.

The amount of oxidizing agent used may vary widely from the stoichiometric amount up to a 100% excess relative to the stoichiometry.

An organic solvent that dissolves the diphosphine is used. The solvent may be chosen from aliphatic, cycloaliphatic and aromatic hydrocarbons, which may or may not be chlorinated. Examples that may be mentioned include dichloromethane, chloroform, carbon tetrachloride and 1,2-dichloroethane.

The concentration of diphosphine in the reaction solvent is preferably between 0.1 and 50 g/l.

The diphosphine, generally dissolved in an adequate solvent, is thus placed in contact with the oxidizing agent.

The reaction is advantageously performed at room temperature, usually between −5° C. and 25° C.

The reaction time is generally between 30 minutes and 6 hours.

The diphosphine is recovered in dioxide form in the organic phase.

The aqueous and organic phases are separated.

A standard work-up of the phases is performed.

Thus, the organic phase is washed with sodium bisulfite, which removes from the aqueous phase the unreacted excess oxidizing agent (peroxide).

A common drying operation is preferably performed, over a drying agent, for example sodium sulfate or magnesium sulfate.

A diphosphine in dioxide form corresponding to formula (III) and denoted in the text hereinbelow as “diphosphine (PO)” is obtained.

In accordance with the present invention, the halogenation reaction of the naphthyl nucleus is performed, which is an electrophilic reaction performed via the action of a halogen, chlorine, bromine or iodine, on the diphosphine in dioxide form and in the presence of a catalyst.

This reaction may be performed in the presence of an iron-based catalyst. Iron turnings or filings are preferably used.

The amount of iron used is such that the ratio between the number of moles of iron and the number of moles of compound of formula (III) ranges between 15 and 30 and more particularly at about 20.

According to one preferred embodiment of the invention, the halogenation takes place in an inert aprotic solvent.

Said solvent should have a boiling point of greater than 60° C. Chlorinated or brominated halogenated hydrocarbons are most particularly used, preferably chloroform, carbon tetrachloride or 1,2-dichloroethane.

A preferred solvent that may be mentioned is 1,2-dichloroethane.

Preferably, the molar ratio of the halogenating agent to the diphosphine (PO) ranges between 15 and 30 and preferably at about 20.

When the process is performed in solution, the concentration of the reagents may vary very widely between 0.01 and 10 mol/l, for example between 0.05 and 1 mol/l.

The halogenation reaction, preferably the bromination, is performed between 20° C. and 100° C. and advantageously in the absence of light so as to avoid spurious radical reactions.

A dihalo diphosphine (PO) corresponding to formula (IIa₁) is thus obtained.

It is recovered in a conventional manner: neutralization of the excess bromine with sodium disulfite, treatment with a base (sodium carbonate or sodium hydrogen carbonate), separation of the aqueous and organic phases and then recovery of the dihalo diphosphine (PO) from the organic solution, which is dried followed by removal of the organic solvent.

In step (ii), the phosphorus atom in oxidized form (PO) is reduced to give the diphosphine of formula (Ia₁).

In a following step, reduction of the diphosphine in dioxide form is performed.

This step consists in subjecting said diphosphine to a reduction performed using a hydrogenosilane.

Said hydrogenosilane may be represented by the following formula:
HSiR_{α}R_{β}R_{δ} (Fₐ)
in said formula:
   R_{α}, R_{β} and R_{δ}, which may be identical or different, represent a hydrogen atom, an alkyl group containing from 1 to 6 carbon atoms, a phenyl group or a chlorine atom,
   at most two of the groups R_{α}, R_{β} and R_{δ} represent a hydrogen atom.

The preferred reducing agents correspond to formula (Fₐ) in which R_{α}, R_{β} and R_{δ} represent a hydrogen atom, a methyl group, a phenyl group or a chlorine atom.

Examples of reducing agents that may be mentioned more particularly include:
AlH₃,
PhSiH₃,
HSiCl₃,
(CH₂)₂HSiCl,
CH₃(HSiCl)
PMHS or polymethylhydrosiloxane.

The invention does not exclude any other type of organosilicon compound comprising an SiH group.

The amount of reducing agent is usually a large stoichiometric excess.

Thus, the ratio between the number of moles of reducing agent and the number of moles of diphosphine (PO) ranges between 10 and 70.

Among the abovementioned reducing agents, a mixture of PhSiH₃ (or PMHS) and of HSiCl₃ is used.

In this case, the amount of PhSiH₃ is such that the ratio between the number of moles of PhSiH₃ and of moles of diphosphine (PO) ranges between 50 and 70.

As regards the amount of HSiCl₃, the ratio between the number of moles of HSiCl₃ and the number of moles of diphosphine (PO) ranges between 10 and 40.

The reduction reaction is performed at a temperature advantageously chosen between 80° C. and 130° C.

At the end of reaction, the medium is cooled to room temperature and the product is recovered in solid form after evaporation.

The product may be washed one or more times using an organic solvent, preferably a halogenated or nonhalogenated aliphatic, cycloaliphatic or aromatic hydrocarbon. Preferred solvents that may be mentioned include pentane, hexane and cyclohexane.

A diphosphine corresponding to formula (Ia₁) is obtained.

The present invention also provides the process for obtaining a diphosphine corresponding to formula (Ia₂): 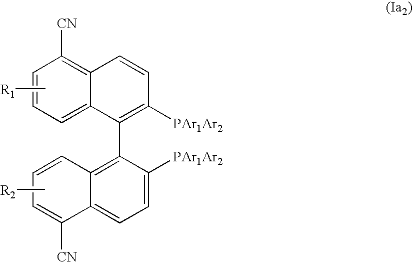
in which R₁, R₂, Ar₁ and Ar₂ are as defined above.

The process of the invention for obtaining the diphosphine of formula (Ia₂) more specifically comprises the following steps:

i) performing the substitution of the two halogen atoms, preferably bromine atoms, with cyano groups by reacting the diphosphine in dioxide and dihalo form in position 5,5′ of formula (IIa₁): 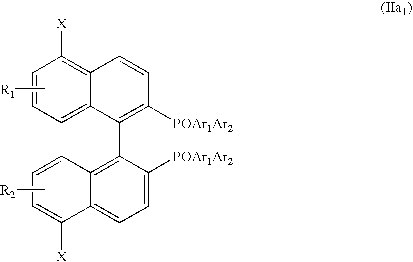
in said formula:
   X, R₁, R₂, Ar₁ and Ar₂ have the meaning given above, using a suitable nucleophilic reagent so as to obtain the corresponding dicyano compound (IIa₂): 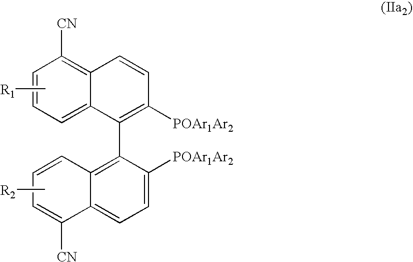
in said formula:
   R₁, R₂, Ar₁ and Ar₂ have the meaning given above,

ii) performing the reduction of the diphosphine in dioxide and dicyano form in position 5,5′ of formula (IIa₂) into the diphosphine of formula (Ia₂): 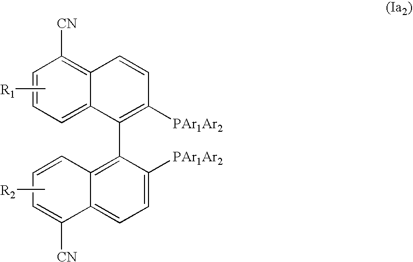
in said formula:
   R₁, R₂, Ar₁ and Ar₂ have the meaning given above.

Starting with a diphosphine in dioxide and dihalo form of formula (IIa₁), the next step is a cyanation reaction, which is a nucleophilic substitution. The two halogen atoms borne by the naphthyl nuclei are replaced with cyano groups via the action of a suitable nucleophilic agent.

To perform this substitution, a person skilled in the art may use any of the methods known in the art.

According to one preferred embodiment of the invention, the nucleophilic agent used is copper(I) or (II) cyanide.

The molar ratio of the copper cyanide to the compound of formula (IIa₁) is preferably greater than 2, advantageously between 2 and 4 and preferably between 2 and 3.

The reaction is preferably performed in a solvent. Examples of solvents that may be mentioned include amides such as dimethylformamide, N-methyl-2-pyrrolidinone and hexamethylphosphorylamide. Dimethylformamide is markedly preferred. Pyridine is also a suitable solvent.

The reaction temperature is advantageously maintained between 50° C. and 200° C. and preferably between 100° C. and 190° C.

The concentration of reagents in the reaction medium generally varies between 0.1 and 10 mol/l, for example between 2 and 7 mol/l.

The isolation of the nitrile involves decomposition of the intermediate complex formed and trapping of the excess cyanide.

The hydrolysis of the intermediate complex may be performed either via the action of hydrated iron chloride or via the action of aqueous ethylenediamine.

In the first case, the reaction medium is poured into an aqueous 50-80% (g/ml) iron chloride solution containing concentrated hydrochloric acid. The resulting solution is heated to 40-80° C. until the complex has completely decomposed. The medium is then decanted and extracted in a conventional manner.

In the second case, the reaction medium is poured into an aqueous ethylenediamine solution (ethylenediamine/water: 1/5-1/1 (v/v), for example 1/3) and the mixture is then stirred vigorously. The medium is then decanted and extracted in a manner known per se.

A person skilled in the art may take inspiration from the studies of L. Friedman et al. published in J.O.C. 1961, 26, 1522, to isolate the nitrile.

Starting with the dicyano diphosphine (PO) of formula (IIa₂), the compound of formula (Ia₂) is obtained by reduction of the diphosphine in dioxide form as described above.

The present invention moreover provides a process for converting the compounds of formula (Ia₂) (which contain two cyano functions) into the corresponding diaminomethyl compounds.

Thus, according to another of its aspects, the invention relates to a process comprising, in addition to the steps (i) and (ii) defined above for the preparation of the diphosphine of formula (Ia₂), an additional step of reduction of the nitrile function of the compound of formula (Ia₂) via the action of a reducing agent, so as to obtain a compound of formula 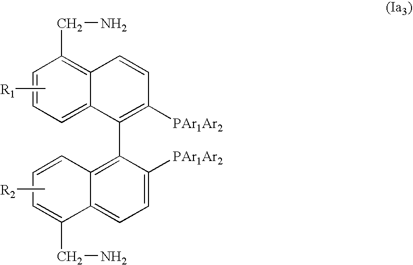
in said formula:
   R₁, R₂, Ar₁ and Ar₂ have the meaning given above.

In a following step, the reduction of the cyano group is performed.

A suitable reducing agent is lithium aluminum hydride (LiAlH₄).

The invention is not intended to be limited to the use of this particular reducing agent.

The reaction is preferably performed in a solvent or a mixture of solvents.

When the reducing agent is LiAlH₄, the solvent advantageously comprises one or more aromatic hydrocarbons (such as benzene, toluene and xylene) as a mixture with one or more ethers.

Ethers that may be mentioned include C₁-C₆ alkyl ethers (diethyl ether and diisopropyl ether), cyclic ethers (dioxane or tetrahydrofuran), dimethoxyethane and diethylene glycol dimethyl ether.

Cyclic ethers such as tetrahydrofuran are preferred.

When the reducing agent is LiAlH₄, a mixture of toluene and tetrahydrofuran in proportions ranging between 70-50/30-50:toluene/tetrahydrofuran (for example 60/40:toluene/THF) (v/v) will more preferably be selected.

The reduction may be performed at a temperature of between 20° C. and 100° C. and preferably between 40° C. and 80° C.

A large excess of the reducing agent is usually used. Thus, the molar ratio of the reducing agent to the compound of formula (Ia₂) generally ranges between 1 and 30, for example between 2 and 20 and especially between 5 and 18.

The concentration of reagents in the medium is variable. It may be maintained between 0.005 and 1 mol/l.

A compound of formula (Ia₃) is obtained, which may be recovered in a conventional manner, especially by treatment with a base (sodium hydroxide) to remove the aluminates, followed by filtration, drying and evaporation.

The compounds of formula (Ia₃) obtained according to the process of the invention are novel and form another subject of the invention.

Among these compounds, the ones that are preferred are those for which Ar₁ and Ar₂ are chosen from a (C₁-C₄)alkyl group from phenyl optionally substituted with methyl or tert-butyl; and (C₅-C₆)cycloalkyl optionally substituted with methyl or tert-butyl.

The compounds of formula (Ia₃) in which Ar₁ and Ar₂ are identical and represent a phenyl group are more preferably chosen.

As a variant, it is possible to convert the two cyano functions of the compounds of formula (Ia₂) into carboxylic acid, imine, hydroxymethyl or amide functions.

The products resulting from these conversions are ligands that may also be used in asymmetric catalysis.

As a variant, the invention provides a process comprising, in addition to steps (i) and (ii) defined above, the step consisting in treating, in acidic medium or in basic medium, the compound of formula (Ia₂) so as to obtain the corresponding carboxylic acid of formula (Ia₄): 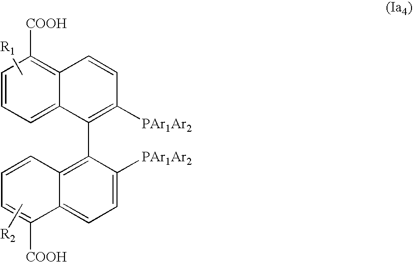
in said formula:
   R₁, R₂, Ar₁ and Ar₂ have the meaning given above.

The conversion of a nitrile function into a carboxylic acid function is described in the standard texts of organic chemistry. Thus, a person skilled in the art can readily determine the appropriate reaction conditions.

One simple way of proceeding consists in using aqueous sodium hydroxide as hydrolysis agent.

As a variant, it is possible to convert the two carboxylic functions of the compounds of formula (Ia₄) into ester, hydroxymethyl or amide functions.

A diphosphine of formula (Ia₅) that corresponds to formula (I) or (I′) in which X₁ and X₂ represent a group —COORₐ is obtained by direct esterification of the compound of formula (Ia₄), performed conventionally in basic medium.

A diphosphine of formula (Ia₆) that corresponds to formula (I) or (I′) in which X₁ and X₂ represent a —CH₂OH group is obtained by reduction of the compound of formula (Ia₄) using, for example, LiAlH₄ or NaH [Gaylord, N. G. Reduction with complex metals hydride; Wiley: NY, 1956, p. 322].

A diphosphine of formula (Ia₇) that corresponds to formula (I) or (I′) in which X₁ and X₂ represent a group —CO—NH—R_{b} is obtained by reaction of the compound of formula (Ia₄) with an amine R_{b}—NH₂ in the presence of a coupling agent, for instance DCC (dicyclohexyl carbamate) (Klausner Y. S., Bodansky M., Synthesis, 1972, 453).

As a variant, it is possible to convert the two aminomethyl functions of the compounds of formula (Ia₃) into amide or urea functions.

A diphosphine of formula (Ia₈) that corresponds to formula (I) or (I′) in which X₁ and X₂ represent a group —CH₂—NH—CO—R_{b} is obtained by reacting the compound of formula (Ia₃) with an acid R_{b}—COOH in the presence of a coupling agent, for instance DCC (Klausner Y. S., Bodansky M., Synthesis, 1972, 453).

A diphosphine of formula (Ia₉) that corresponds to formula (I) or (I′) in which X₁ and X₂ represent a group —CH₂—NH—CO—NH—R_{b} is obtained by reacting the compound of formula (Ia₃) with an isocyanate R_{b}—NCO generally in solvent medium [Rob Ter Halle, Benoit Colasson, Emanuelle Schulz, Michel Spagnol, Marc Lemaire, Tetrahedron Letters, 2000, (41) 643-646].

A diphosphine of formula (Ia₁₀) that corresponds to formula (I) or (I′) in which X₁ and X₂ represent a group —CH₂—N═CH—Rₐ is obtained by reacting the compound of formula (Ia₃) with an aldehyde Rₐ—CHO (Farrar W. V., Rec. Chem. Prog., 1968, 29, 85).

A diphosphine of formula (Ia₁₁) that corresponds to formula (I) or (I′) in which X₁ and X₂ represent a —CH₂—N═C═O group is obtained by reaction of the compound of formula (Ia₃) with phosgene, performed according to the teaching of the literature especially by Jerry March, Advanced Organic Chemistry, 5th Edition, John Wiley and Sons, p. 507.

A diphosphine of formula (Ia₁₂) that corresponds to formula (I) or (I′) in which X₁ and X₂ represent a —CH₂—NH₄⁺ group is obtained by placing the compound of formula (Ia₃) in contact with an acid, preferably hydrobromic acid, at room temperature, in a suitable solvent capable of dissolving the compound of formula (Ia₃). A suitable solvent is, for example, an aprotic solvent such as a halogenated aliphatic hydrocarbon (such as dichloromethane or trichloroethylene) or an optionally halogenated aromatic hydrocarbon such as toluene or halogenated toluene. The diphosphine of formula (Ia₁₂) is recovered in aqueous phase.

Diphosphines of formula (Ia₁₃) or (Ia₁₄) that correspond to formula (I) or (I′) in which X₁ and X₂ represent, respectively, a group —NHRₐ or a group —N(Rₐ)₂ are obtained by reacting, respectively, the diphosphine in dioxide and dihalo form of formula (IIa₁) and an amine RₐNH₂ or (Rₐ)₂NH (Kazankov M. V., Ginodman L. G., J. Organic. Chem., USSR, 1975, 11, 451) followed by reduction of the diphosphine in dioxide form as described above.

A diphosphine of formula (Ia₁₅) that corresponds to formula (I) or (I′) in which X₁ and X₂ represent a group —N═CH—Rₐ is obtained by reacting ammonia with the diphosphine in dioxide and dihalo form of formula (IIa₁) followed by reaction of the amino group with a compound of the type Rₐ—CHO, followed by reduction of the diphosphine in dioxide form as described above.

A diphosphine of formula (Ia₁₆) that corresponds to formula (I) or (I′) in which X₁ and X₂ represent an —NH—NH₂ group is obtained by reacting hydrazine with the diphosphine in dioxide and dihalo form of formula (IIa₁) (Kazankov M. V., Ginodman L. G., J. Org. Chem., USSR, 1975, 11, 451) followed by reduction of the diphosphine in dioxide form as described above.

A diphosphine of formula (Ia₁₇) that corresponds to formula (I) or (I′) in which X₁ and X₂ represent an —N═N⁺═N⁻ group is obtained by reacting HN₃ or NaN₃ with the diphosphine in dioxide and dihalo form of formula (IIa₁) (Scriven E. F. V., Turnbull K., Chem. Rev., 1988, 88, 297) followed by reduction of the diphosphine in dioxide form as described above.

A diphosphine of formula (Ia₁₈) that corresponds to formula (I) or (I′) in which X₁ and X₂ represent an —N═C═O group is obtained by reacting the compound of formula (Ia₁₃) with phosgene, performed according to the teaching of the literature, especially by Jerry March, Advanced Organic Chemistry, 5th Edition, John Wiley and Sons, p. 507.

As a variant, the invention also provides a diphosphine of formula (Ia₁₉) in which X₁ and X₂ represent a hydrocarbon-based group R chosen from alkyl, alkenyl, alkynyl, cycloalkyl, aryl and arylalkyl groups and which is obtained by preparing the organomagnesium reagent corresponding to the dihalo diphosphine (IIa₁) in dioxide form by reacting the latter with magnesium, followed by reaction of the reagent obtained with the halogenated hydrocarbon R—X₀ (X₀=Br or Cl) (Kharasch M. S., Reinmuth O., Grignard reactions of nonmetallic substances; Prentice-Hall: Englewood Cliffs, N.J., 1954, 5). A reduction of the diphosphine in dioxide form is then performed as described above.

As a variant, the invention also provides a diphosphine of formula (Ia₂₀) in which X₁ and X₂ represent an alkyl group substituted with one or more halogen atoms, especially with fluorine atoms. It is preferably a perfluoroalkyl group of the type —(CH₂)ₚF_{q} in which p is between 1 and 15 and preferably between 6 and 10, and q is between 3 and 21 and preferably between 13 and 25.

The production of such a diphosphine is obtained by reacting the diphosphine in dioxide and dihalo form of formula (IIa₁) with the corresponding iodo species I(CH₂)ₚF_{q}, p and q having the meanings given above, in the presence of copper, optionally a base, and a polar solvent.

The ratio between the number of moles of diphosphine of formula (IIa₁) and the number of moles of iodoperfluoro compound ranges between 1 and 5 and preferably between 1 and 3.

The ratio between the number of moles of copper and the number of moles of dibromo diphosphine ranges between 5 and 10.

As regards the base, use is made of a trapping base especially such as those mentioned above, in particular bipyridine.

The ratio between the number of moles of base and the number of moles of dibromo diphosphine ranges between 0.1 and 1.

The reaction advantageously takes place in a polar solvent, for instance dimethyl sulfoxide, dimethylformamide or fluorobenzene.

The reaction takes place between 60° C. and 100° C. and preferably between 70° C. and 80° C.

The reaction lasts between 24 and 36 hours.

At the end of reaction, the mixture is diluted with a solvent (for example dichloromethane), the copper is separated out by filtration and the organic phase is recovered, which is conventionally washed with water and then with a dilute acid solution (for example 1N HCl) and then with sodium hydrogen carbonate.

The organic phase is dried and the solvent is then removed by evaporation.

The diphosphine in dioxide form containing perfluoroalkyl groups in positions 5 and 5′ is recovered. A reduction of the diphosphine in dioxide form is then performed as described above.

As a variant, the invention also provides a diphosphine of formula (Ia₂₁) in which X₁ and X₂ represent a hydroxyl group. It is obtained from the diphosphine in dioxide and dihalo form of formula (IIa₁), according to an aromatic nucleophilic substitution with OH— [Fyfe, C. A. in Patai The Chemistry of the hydroxyl group, Pt. 1, Wiley: NY, 1971, p. 83]. A reduction of the diphosphine in dioxide form is then performed as described above.

The invention also provides a diphosphine of formula (Ia₂₂) in which X₁ and X₂ represent a group —OCORₐ. It is obtained from the diphosphine of formula (Ia₁₇) by reaction with the carboxylic acid RₐCOOH or a derivative (halide or anhydride), according to a standard esterification reaction.

The process of the invention may be performed starting with an optically active compound of formula (IV) with conservation of the chirality from the start to the end of the synthesis.

Thus, starting with (S)-BINAP, (S)-5,5′-diaminomethyl-2,2′-bis(diphenylphosphino)-1,1′-binaphthyl is obtained. Starting with (R)-BINAP, (R)-5,5′-diaminomethyl-2,2′-bis(diphenylphosphino)-1,1′-binaphthyl is obtained.

According to another aspect of the invention, the invention relates to the use of diphosphine in which the naphthyl groups are substituted in the 5,5′ position with two identical functional groups capable of reacting with polymerizable monomers, leading to a racemic or optically active polymer.

The diphosphines used correspond to formula (I′).

In formula (I′), X₁ represents an aminomethyl group —CH₂—NH₂, a hydroxyl group —OH, a hydroxymethyl group —CH₂—OH, a carboxylic or ester group —COORₐ (Rₐ represents a hydrogen atom or an alkyl, cycloalkyl, arylalkyl or phenyl group, more preferably a hydrogen atom or a C₁-C₂ alkyl group), an isocyanato group —N═C═O or an isocyanatomethyl group —CH₂—N═C═O.

Advantageously, they are diphosphines corresponding to formulae (Ia₂₁), (Ia₃), (Ia₄), (Ia₅), (Ia₆), (Ia₁₁) and (Ia₁₈).

Another subject of the invention thus lies in optically active polymers comprising the chiral diphosphine of formula (I′) as polymer units.

Another subject of the invention consists of the use of the optically active polymer as a ligand in the preparation of metal complexes for asymmetric catalysis.

The polymer of the invention consists of a sequence of two types of units.

The first type of unit is the chiral diphosphine residue corresponding to formula (I′) and bearing two identical polymerizable functional groups.

The second type of unit is a monomer residue that is polymerizable with said functional groups, i.e. a monomer comprising at least two identical functional groups capable of reacting with the functional groups of the chiral diphosphine.

The preferred monomer is difunctional and may be represented by formula (X) below:
Y₁-M-Y₁ (X)
in which:
   M represents a divalent hydrocarbon-based group of aliphatic, alicyclic and/or aromatic nature,
   Y₁ represents a functional group, preferably a carboxylic, ester, hydroxyl, amino, isocyanato, aldehyde or ketone group.

The size of the group M will be adjusted by a person skilled in the art as a function of the final use of the ligand and especially as a function of the reaction that the metal complex formed from this polymer ligand is intended to catalyze.

Preferred meanings will be given later for the reagents preferentially chosen.

It will be pointed out that the monomers most often used correspond to formula (X) in which M represents a C₁-C₁₂ and preferably C₁-C₆ alkylene chain; a cycloalkylene and preferably a cyclohexylene group; an arylene group, preferably phenylene, tolylene or naphthalene.

Thus, the optically active polymer resulting from the polymerization of the diphosphine of formula (I′) and of the monomer of formula (X) comprises the following repeating unit: 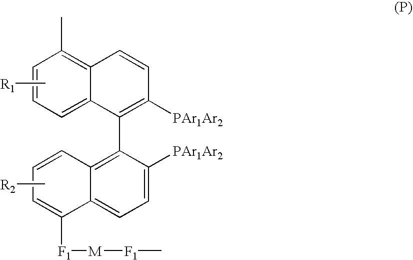
in which
   R₁ and R₂, which may be identical or different, represent a hydrogen atom or a substituent,
   Ar₁ and Ar₂ independently represent an alkyl, alkenyl, cycloalkyl, aryl or arylalkyl group,
   M represents a divalent hydrocarbon-based group of aliphatic, alicyclic and/or aromatic nature;
   F₁ represents a functional group resulting from the reaction:
      of the group X₁ chosen from the following groups: aminomethyl, hydroxyl, hydroxymethyl, carboxylic, ester, isocyanato, isocyanatomethyl,
      and of the group Y₁ chosen from carboxylic, ester, hydroxyl, amino, isocyanato, aldehyde and ketone groups,
   the degree of polymerization is preferably between 2 and 100 and better still between 2 and 50.

The choice of these functions, combined with the choice of the polymerizable monomers, determines the nature of the resulting polymer.

Thus, F₁ more particularly represents:
a urea group (F₁) resulting from the reaction of an aminomethyl group (X₁) with an isocyanato group (Y₁) or an isocyanato or isocyanatomethyl group (X₁) with an amino group (Y₁),
a urethane group (F₁) resulting from the reaction of an isocyanato or isocyanatomethyl group (X₁) with a hydroxyl group (Y₁) or a hydroxyl or hydroxymethyl group (X₁) with an isocyanato group (Y₁),
an ester group (F₁) resulting from the reaction of a carboxylic or ester group (X₁) with a hydroxyl group (Y₁) or a hydroxyl or hydroxymethyl group (X₁) with a carboxylic or ester group (Y₁),
an amide group (F₁) resulting from the reaction of a carboxylic group (X₁) with an amino group (Y₁) or an aminomethyl group (X₁) with a carboxylic group (Y₁),
an imine group (F₁) resulting from the reaction of an aminomethyl group (X₁) with an aldehyde or ketone group (Y₁).

The present invention encompasses all types of polymers and especially linear, branched or crosslinked polymers. Mention may be made of polymers such as polyester, polyurethane, polyamide, polyurea, polyimine and polyimide.

The preferred polymers are linear polymers, but the invention does not exclude crosslinked polymers obtained by using a polymerizable monomer comprising more than two functional groups, for example three groups.

The choice of monomers placed in contact will be made as a function of their ease of access.

Thus, the invention favors the chiral substance bearing in position 5,5′ two aminomethyl groups.

The compounds preferably used, corresponding to formula (Ia₃) in which Ar₁ and Ar₂ are independently chosen from a (C₁-C₄)alkyl group or a phenyl group optionally substituted with methyl or tert-butyl; and (C₅-C₆)cycloalkyl optionally substituted with methyl or tertbutyl.

Those of formula (Ia₃) in which Ar₁ and Ar₂ are identical and represent a phenyl group are more preferably chosen.

In accordance with the invention, one of the diphosphines corresponding to one of the formulae (I′) is reacted with a polymerizable monomer. It is preferentially chosen to use only one polymerizable monomer.

Classes of monomers that may especially be mentioned include diacids, diesters, diols, diisocyanates, dialdehydes and diketones.

Although the invention is not intended to be specifically limited thereto, polyamides, polyureas and polyimides will be described in further detail.

The polyureas, polyamides and polyimides of the invention may be prepared starting with a chiral diphosphine consisting of a chiral substance bearing, as functional groups, two aminomethyl groups, and which corresponds to the formulae (Ia₃).

Polyureas

When the targeted polymer is a polyurea, it may be synthesized by polymerization of a diphosphine bearing two —CH₂—NH₂ groups with one or more di- or polyisocyanates.

The nature of the isocyanate compound is not critical per se.

Preferably, the diisocyanate is a diisocyanate of formula (Xa):
O═C═N-J-N═C═O (Xa)
in which:
   J represents a divalent hydrocarbon-based group of aliphatic, alicyclic and/or aromatic nature.

The size of the group J will be adjusted by a person skilled in the art as a function of the final use of the ligand and especially as a function of the reaction that the metal complex formed from this polymer ligand is intended to catalyze.

The catalytic sites of the polymer of the invention are located on the diphosphine-based units. The size of the group J thus determines the spacing of the catalytic sites.

The group J is, for example, a C₁-C₁₆ and preferably C₁-C₁₂ alkylene chain, optionally interrupted with one or more (preferably 1 to 4 and better still 1 to 2) hetero atoms chosen from O, N and S, said chain optionally comprising one or more unsaturations (preferably 1 to 4 and better still 1 to 2); a group —(CH₂)ₐ—K—(CH₂)_{b}— in which a and b are, independently, an integer from 0 to 6 and K represents (C₆-C₈)cycloalkylene; a group —(CH₂)ₐ-L-(CH₂)_{b}— in which a and b are as defined above and L represents (C₆-C₁₀)arylene; a group —(CH₂)ₐ—Vₒ—(CH₂)_{b}— in which a and b are as defined above and Vₒ represents a 5- to 8-membered heteroarylene comprising 1 to 3 hetero atoms chosen from O, N and S; or alternatively a group -Mₒ-Q-Mₒ- in which Mₒ is chosen from (C₃-C₈)cycloalkylene and (C₆-C₁₀)arylene and Q represents a bond, a sulfur atom, an oxygen atom, (C₁-C₄)alkylene, —SO—, —SO₂— or —CO—.

When J contains an alkylene chain, it is linear or branched and preferably contains 1 to 6 carbon atoms. When this alkylene chain comprises a nitrogen atom, it bears a (C₁-C₆)alkyl group or a hydrogen atom.

When J contains cycloalkylene, J is preferably cyclohexylene.

When J contains arylene, J is preferably phenylene or naphthalene.

When J represents —(CH₂)ₐ-L-(CH₂)_{b}—, —(CH₂)ₐ—K—(CH₂)_{b}— or —(CH₂)ₐ—Vₒ—(CH₂)_{b}—, a and b are preferably identical.

The term “heteroarylene” means a divalent group corresponding to a heterocycle in which two hydrogen atoms have been replaced with two bonds.

Heteroarylenes derived from the following heterocycles are preferred: furan, thiophene, pyrrole, oxazole, thiazole, imidazole, pyrazole, isoxazole, isothiazole, pyridine, pyridazine, pyrimidine, pyrazine, indolizine, indole, isoindole, benzofuran, benzothiophene, benzimidazole, benzothiazole, quinoline, isoquinoline, cinnoline, phthalazine, quinazoline, naphthyridine and pteridine. The heteroarylene is very advantageously derived from imidazole, benzimidazole, pyrimidine or quinazoline.

When J represents -Mₒ-Q-Mₒ-, Q is preferably (C₁-C₂)alkylene or a bond, and Mₒ is preferably cyclohexylene or phenylene.

The group J as defined above may bear one or more substituents chosen from a halogen atom, a C₁-C₆ alkyl group, a C₁-C₆ alkoxy group, an oxo group and a di(C₁-C₆)alkylamino group.

Examples of diisocyanates that are particularly suitable are:
1,2-diisocyanatopropane,
1,4-diisocyanatobutane
2,6-diisocyanatotoluene,
1,12-diisocyanatododecane,
trans-1,4-cyclohexanediisocyanate,
4,4′-diisocyanatodiphenylmethane,
4,4′-diisocyanato-3,3′-dimethyldiphenylmethane,
1,5-diisocyanatonaphthalene.

The condensation of the diisocyanate with the diphosphine is performed under suitable conditions that are readily determined by a person skilled in the art.

These polymerization conditions are preferably adjusted so as to obtain a polymer with a degree of polymerization of from 2 to 100, preferably from 5 to 100, for example from 2 to 50 and better still from 4 to 25.

Polyureas with a degree of polymerization of from 3 to 8 are particularly suitable for use.

A person skilled in the art will select the degree of polymerization such that the resulting polymer is insoluble in the solvent or mixture of solvents used in the asymmetric reaction that needs to be catalyzed.

The choice of the polymerization method is not critical according to the invention.

One particularly suitable method is solution polymerization.

The solvent is generally a polar aprotic solvent chosen from an optionally halogenated aliphatic hydrocarbon, for example methylene chloride, chloroform, carbon tetrachloride or 1,2-dichloroethane; an optionally halogenated aromatic hydrocarbon, for example chlorobenzene or dichlorobenzene; an ether such as diethyl ether, diisopropyl ether, tetrahydrofuran, dioxane, diethylene glycol dimethyl ether and glymes, and especially 1,2-dimethoxyethane; an amide such as formamide, dimethylformamide, dimethylacetamide, N-methyl-2-pyrrolidinone or hexamethylphosphorylamide; a nitrile such as acetonitrile or isobutyronitrile; and dimethyl sulfoxide.

The concentration of reagents in the solution varies very widely as a function of the solubility of the reagents. It is generally between 0.05 and 1 mol/l and preferably between 0.01 and 1 mol/l, for example 0.1 mol/l.

Preferably, the diisocyanate is used in slight excess relative to the diphosphine, although, strictly speaking, a stoichiometric ratio of these two compounds may be suitable.

Thus, the molar ratio of the diisocyanate to the diphosphine is generally set at between 1 and 1.5, for example between 1 and 1.3.

The temperature at which the polymerization is performed is determined as a function of the reactivity of the various reagents and of the desired degree of polymerization. As a guide, the temperature ranges between −20° C. and 100° C., preferably between room temperature and 100° C., for example between 15 and 100° C. and better still between 15 and 40° C. It is advantageously 20° C.

The polymerization is performed conventionally by dissolving the reagents in the solvent, mixing, optionally heating the reaction medium, and then isolating the polymer, for example by filtration of the reaction medium. It will be noted that it may be necessary, before isolation of the polymer, to deactivate the ends of the polymer chain, and especially the unreacted isocyanate functions, by addition of a C₁-C₆ alkanol, for example propanol, isopropanol, methanol or ethanol, or even tert-butyl alcohol.

An example of a polymer that is particularly preferred is a polymer containing as repeating unit: 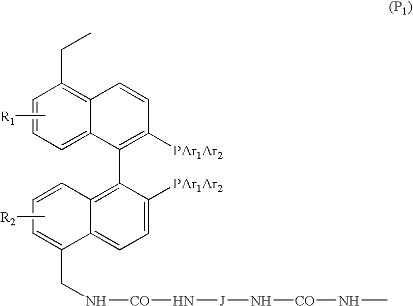
in which
   R₁ and R₂, which may be identical or different, represent a hydrogen atom or a substituent,
   Ar₁ and Ar₂ independently represent an alkyl, alkenyl, cycloalkyl, aryl or arylalkyl group,
   J has the meaning given above,
   the degree of polymerization is preferably between 2 and 100 and better still between 2 and 50.
      Polyamides

When the polymer is a polyamide, it may be prepared by condensation of a chiral diphosphine bearing two aminomethyl functions with one or more dicarboxylic acids or activated derivatives thereof.

The dicarboxylic acid advantageously corresponds to formula (Xb) below:
HOOC—W—COOH (Xb)
in which W is as defined for J above.

The preferred meanings of J indicated above are also preferred meanings of W.

The group W may be substituted with one or more halogen atoms or oxo, (C₁-C₆)alkyl, (C₁-C₆)alkoxy or di(C₁-C₆)alkylamino groups.

Among these dicarboxylic acids, the following are preferred:
the aliphatic acids chosen from:
   malonic acid,
   succinic acid,
   glutaric acid,
   adipic acid,
   2,4-dimethyladipic acid,
   pimelic acid,
   suberic acid,
   azelaic acid,
   sebacic acid,
   dodecanedioic acid,
   fumaric acid,
   maleic acid,
   methyliminodiacetic acid,
   3-dimethylaminohexanedioic acid,
cycloalkanedicarboxylic acids and especially:
   1,4-cyclohexanedicarboxylic acid,
the aromatic dicarboxylic acids chosen from:
   phthalic acid,
   isophthalic acid,
   terephthalic acid,
   phenylenediacetic acid,
   1,5-naphthalenedicarboxylic acid,
   4,4′-diphenyldicarboxylic acid,
   3,3′-diphenyldicarboxylic acid,
   4,4′-dicarboxydiphenyl sulfone,
   3,3′-dicarboxydiphenyl sulfone.

One particularly preferred group of dicarboxylic acids consists of the following acids:
succinic acid,
adipic acid,
fumaric acid,
isophthalic acid,
terephthalic acid,
1,5-naphthalenedicarboxylic acid,
4,4′-diphenyldicarboxylic acid,
3,3′-diphenyldicarboxylic acid.

The activated derivative of the dicarboxylic acid more generally denotes the dicarboxylic acid compound in which one or two of the carboxylic functions have been modified so as to increase their reactivity.

Activated derivatives of dicarboxylic acid are obtained, for example, by formation of an anhydride bond or of a group —COY in which Y is a halogen atom such as bromine or chlorine.

Other activated derivatives of dicarboxylic acids are those bearing, instead of the carboxylic functions, groups —COT in which T denotes an azide, imidazolide, p-nitrophenoxy, 1-benzotriazole, N—O-succinimide, acyloxy (such as pivaloyloxy), (C₁-C₄ alkoxy)carbonyloxy, or dialkyl- or dicycloalkyl-O-ureide group.

The condensation of the diphosphine with the dicarboxylic acid or the activated derivative thereof is generally performed in a solvent.

When the dicarboxylic acid is used in unmodified form, it may be advantageous to perform the condensation in the presence of a catalyst, for example a strong acid such as hydrochloric acid or sulfuric acid, or alternatively in the presence of a coupling agent such as those commonly used in peptide synthesis.

Among the known coupling agents that may be mentioned are N-hydroxylated derivatives such as N-hydroxysuccinimide and 1-hydroxybenzotriazole; disulfides such as dipyridyl 2,2′-disulfide; succinic acid derivatives such as N,N′-disuccinimidyl carbonate; phosphinic chlorides such as N,N′-bis(2-oxo-3-oxazolidinyl)phosphinic chloride; oxalates such as N,N′-disuccinimidyl oxalate (DSO), diphthalimide N,N′-oxalate (DPO), N,N′-bis(norbornenylsuccinimidyl)oxalate (BNO), 1,1′-bis(benzotriazolyl)oxalate (BBTO), 1,1′-bis(6-chlorobenzotriazolyl)oxalate (BCTO) or 1,1′-bis(6-trifluoromethylbenzotriazolyl)oxalate (BTBO); triarylphosphines such as triphenylphosphine; a combination of a di(lower alkyl)azodicarboxylate and of a triarylphosphine, such as a combination of diethyl azodicarboxylate and of triphenylphosphine; N-(lower alkyl)-5-aryl-isoxazolium-3′-sulfonates such as N-ethyl-5-phenylisoxazolium-3′-sulfonate; carbodiimide derivatives, including N′,N′-dicycloalkylcarbodiimides such as N′,N′-dicyclohexylcarbodiimide (DCC) or 1-ethyl-3-(3-dimethylaminopropyl)carbodiimide (EDAPC); diheteroaryl diselenides such as di-2-pyridyl diselenide; arylsulfonyltriazolides such as p-nitrobenzenesulfonyltriazolide; 2-halo-1-(lower alkyl)pyridinium halides such as 2-chloro-1-methylpyridinium iodide; diarylphosphorylazides such as diphenylphosphorylazide (DPPA); imidazole derivatives such as 1,1′-oxalyldiimidazole or N,N′-carbonyldiimidazole; benzotriazole derivatives such as 1-hydroxybenzotriazole (HOBT); and dicarboximide derivatives such as N-hydroxy-5-norbornene-2,3-dicarboximide (HONB). Among these, carbodiimide derivatives are preferred.

The reaction may take place within a wide temperature range.

According to the reactivity of the reagents used, the reaction temperature ranges between −20° C. and 100° C.

When the polymerization involves the reaction of an activated derivative of the dicarboxylic acid with a diphosphine, a relatively low temperature, preferably of between 0° C. and 40° C., is sufficient.

Conversely, when the dicarboxylic acid is used in unmodified form in the reaction, the temperature is preferably between 50 and 80° C.

The concentration of reagents in the reaction medium is not a determining factor according to the invention. It may range between 0.05 and 1 mol/l.

In general, the molar ratio of the dicarboxylic acid or of the activated derivative thereof to the diphosphine ranges between 0.8 and 1.5 and preferably between 0.9 and 1.2.

A typical procedure, illustrating the preparation of a polyamide starting with a carboxylic acid chloride, is as follows.

3.75 mmol of the carboxylic acid chloride are added to a solution of 4.16 mmol of diphosphine in 5 ml of N,N-dimethylacetamide. The reaction mixture is stirred overnight at room temperature (18 to 30° C.). The polyamide is then precipitated from 150 ml of distilled water. The polymer is filtered off on a sinter funnel, and washed with water and then with isopropanol.

The general conditions for performing the polymerization and for isolating the polymer will be readily determined by a person skilled in the art, given that the preferred polyamides of the invention have a degree of polymerization of between 2 and 100, for example between 5 and 100, preferably between 2 and 50 and better still between 4 and 25.

A person skilled in the art will select the degree of polymerization such that the resulting polymer is insoluble in the solvent or mixture of solvents used in the asymmetric reaction that needs to be catalyzed.

An example of a preferred polymer is a polymer containing as repeating unit: 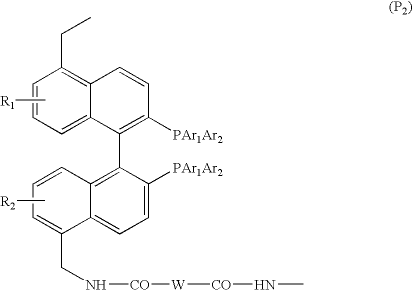
in which
   R₁ and R₂, which may be identical or different, represent a hydrogen atom or a substituent,
   Ar₁ and Ar₂ independently represent an alkyl, alkenyl, cycloalkyl, aryl or arylalkyl group,
   W has the meaning given for J,
   the degree of polymerization is preferably between 2 and 100 and better still between 2 and 50.
      Polyimides

When the polymer is a polyimide, it may be prepared by condensation of a diphosphine bearing two aminoethyl functions with one or more tetracarboxylic acids or tetracarboxylic acid dianhydrides.

For the preparation of these polyimides, a person skilled in the art may take inspiration from D. C. Sherrington, Chem. Commun., 1998, 2275-2286.

Advantageously, the polyimides are prepared in two steps.

In a first step, a polyamide is formed. This step is performed, for example, at a temperature of between 15 and 50° C. and preferably between 20 and 30° C., in a polar aprotic solvent (such as an amide such as formamide, dimethylacetamide or N-methyl-2-pyrrolidinone, preferably dimethylacetamide).

In a second step, the polyimide is formed. This second step may be performed by treatment with a mixture of acetic anhydride and pyridine at a temperature of between −100° C. and 10° C. and preferably between −78° C. and −50° C.

According to another variant of the invention, the polymer may be a polyurethane.

Polyurethanes

When the polymer is a polyurethane, it may be prepared by condensation of a chiral diphosphine bearing two hydroxyl or hydroxymethyl groups with a monomer of the diisocyanate type.

In this case, a catalysis with a tin salt is often necessary. Reference may be made especially to the article by M. Lemaire et al. J. Mol. Cat. A. 2002, Vol. 182-183, 239-247.

According to one of its aspects, the invention thus relates to a process for preparing a polymer of the invention, comprising the polymerization of a chiral diphosphine of formula (I′) with one or more polymerizable monomers, preferably of formula (X); said chiral phosphine consisting of a chiral substance bearing two identical functional groups capable of reacting with said polymerizable monomers.

The invention also relates to the racemic polymer corresponding to the optically active polymer of the invention.

This polymer may be prepared simply by polymerization of the appropriate diphosphine with one or more polymerizable monomers, said diphosphine bearing two identical functional groups capable of reacting with said polymerizable monomers.

Preferably, the diphosphines used in this reaction are racemic diphosphines corresponding to the preferred chiral diphosphines defined above. Thus, according to one preferred embodiment of the invention, the racemic diphosphine consists of a racemic base skeleton of formula (I′) bearing two identical functional groups.

Similarly, the polymerizable monomers preferably used for this polymerization are those described above for the preparation of the optically active polymers.

The operating conditions for this polymerization will be readily determined by a person skilled in the art by analogy with those proposed for the polymerization reaction leading to the optically active polymer.

The diphosphines obtained according to the processes of the invention and those that are insolubilized in the form of a polymer as described above may be used as ligands in the preparation of metal complexes for the asymmetric catalysis of the following reactions: hydrogenation, hydrosilylation, hydroboration of unsaturated compounds, epoxidation of allylic alcohols, vicinal hydroxylation, hydrovinylation, hydroformylation, cyclopropanation, olefin isomerization, propylene polymerization, addition of organometallic compounds to aldehydes, allylic alkylation, reactions of aldol type, Diels-Alder reactions and, in general, reactions for formation of C—C bonds (such as allylic substitutions or Grignard cross-couplings).

According to one preferred embodiment of the invention, the complexes are used for the hydrogenation of C═O, C═C and C═N bonds.

One subject of the invention is thus novel complexes comprising the chiral diphosphine of the invention or the optically active polymer as defined above and a transition metal.

As examples of transition metals capable of forming complexes, mention may be made especially of metals such as rhodium, ruthenium, rhenium, iridium, cobalt, nickel, platinum and palladium.

Among the abovementioned metals, rhodium, ruthenium and iridium are preferred.

Thus, according to another of its aspects, the invention relates to the use of diphosphine optionally in insoluble form for the preparation of a metal complex of a transition metal intended for asymmetric catalysis, and more especially of a ruthenium, iridium or rhodium complex.

Specific examples of said complexes of the present invention are given hereinbelow, without any limiting nature.

In the following formulae, P represents a ligand according to the invention, i.e. diphosphine or diphosphine insolubilized in the form of a polymer.

A preferred group of rhodium and iridium complexes is defined by the formula:
[MeLig₂P]Y₁ (F₁)
in which:
   P represents a ligand according to the invention;
   Y₁ represents an anionic coordinating ligand;
   Me represents iridium or rhodium; and
   Lig represents a neutral ligand.

Among these compounds, the ligands that are particularly preferred are those in which:
Lig represents an olefin containing from 2 to 12 carbon atoms;
Y₁ represents an anion PF₆⁻, PCl₆⁻, BF₄⁻, BCl₄⁻, SbF₆⁻, SbCl₆⁻, BPh₄⁻, ClO₄⁻, CN⁻, CF₃SO₃⁻, halogen, preferably Cl⁻ or Br⁻, a 1,3-diketonate, alkylcarboxylate or haloalkylcarboxylate anion with a lower alkyl (preferably of C₁-C₆) group, a phenylcarboxylate or phenoxide anion in which the benzene ring may be substituted with lower alkyl (preferably C₁-C₆) groups and/or halogen atoms.

In formula (F₁), Lig₂ may represent two ligands Lig as defined above or a bidentate ligand such as a linear or cyclic, polyunsaturated bidentate ligand comprising at least two unsaturations.

It is preferable according to the invention for Lig₂ to represent 1,5-cyclooctadiene or norbornadiene, or for Lig to represent ethylene.

The term “lower alkyl groups” generally means a linear or branched alkyl group containing from 1 to 4 carbon atoms.

Other iridium complexes are those of formula:
[IrLigP]Y₁ (F₂)
in which Lig, P and Y₁ are as defined for formula (F₁).

A preferred group of ruthenium complexes consists of the compounds of formula:
[RuY₁¹Y₁²P] (F₃)
in which:
   P represents a ligand according to the invention;
   Y₁¹ and Y₁², which may be identical or different, represent an anion PF₆⁻, PCl₆⁻, BF₄⁻, BCl₄⁻, SbF₆⁻, SbCl₆⁻, BPh₄⁻, ClO₄⁻, CF₃SO₃⁻, a halogen atom, more particularly chlorine or bromine, or a carboxylate anion, preferably acetate or trifluoroacetate.

Other ruthenium complexes are those corresponding to formula XIV below:
[RuY₁³arPY₁⁴] (F₄)
in which:
   P represents a ligand according to the invention;
   ar represents benzene, p-methylisopropylbenzene or hexamethylbenzene;
   Y₁³ represents a halogen atom, preferably chlorine or bromine;
   Y₁⁴ represents an anion, preferably a PF₆⁻, PCl₆⁻, BF₄⁻, BCl₄⁻, SbF₆⁻, SbCl₆⁻, BPh₄⁻, ClO₄⁻ or CF₃SO₃⁻ anion.

It is also possible to use in the process of the invention complexes based on palladium and platinum.

As more specific examples of said complexes, mention may be made, inter alia, of Pd(hal)₂P and Pt(hal)₂P in which P represents a ligand according to the invention and hal represents halogen, for instance chlorine.

The complexes comprising a ligand according to the invention and the transition metal may be prepared according to the known processes described in the literature.

The complexes are generally prepared from a precatalyst, the nature of which varies according to the transition metal selected.

In the case of rhodium complexes, the precatalyst is, for example, one of the following compounds: [Rh^{I}(CO)₂Cl]₂; [Rh^{I}(COD)Cl]₂ in which COD denotes cyclooctadiene; or Rh^{I}(acac) (CO)₂ in which acac denotes acetylacetonate.

In the case of ruthenium complexes, precatalysts that are particularly suitable are bis(2-methylallyl)cycloocta-1,5-dieneruthenium and [RuCl₂(benzene)]₂. Mention may also be made of Ru(COD) (η³-(CH₂)₂CHCH₃)₂.

By way of example, starting with bis(2-methylallyl)cycloocta-1,5-dieneruthenium, a solution or suspension containing the metal precatalyst, a ligand and a fully degassed solvent such as acetone (the ligand concentration of the solution or suspension ranging between 0.001 and 1 mol/l) is prepared, to which is added a methanolic solution of hydrobromic acid. The ratio of the ruthenium to bromine advantageously ranges between 1:1 and 1:4 and preferably between 1:2 and 1:3. The molar ratio of the ligand to the transition metal is about 1. It may be between 0.8 and 1.2.

When the precatalyst is [RuCl₂(benzene)]₂, the complex is prepared by mixing together the precatalyst, the ligand and an organic solvent and optionally maintaining at a temperature of between 15 and 150° C. for 1 minute to 24 hours and preferably from 30 to 120° C. for 10 minutes to 5 hours.

Solvents that may be mentioned include aromatic hydrocarbons (such as benzene, toluene and xylene), amides (such as formamide, dimethylformamide, dimethylacetamide, N-methyl-2-pyrrolidinone or hexamethylphosphorylamide) and alcohols (such as ethanol, methanol, n-propanol and isopropanol), and mixtures thereof.

Preferably, when the solvent is an amide, especially dimethylformamide, the mixture of the ligand, the precatalyst and the solvent is heated to between 80 and 120° C.

As a variant, when the solvent is a mixture of an aromatic hydrocarbon (such as benzene) with an alcohol (such as ethanol), the reaction medium is heated to a temperature of between 30 and 70° C.

The catalyst is then recovered according to the standard techniques (filtration or crystallization) and is used in asymmetric reactions. However, the reaction that needs to be catalyzed by the complex thus prepared may be performed without intermediate isolation of the catalyst complex.

The case of hydrogenation is outlined in detail in the text hereinbelow.

The unsaturated substrate, dissolved in a solvent comprising the catalyst, is placed under hydrogen pressure.

The hydrogenation is performed, for example, at a pressure ranging between 1.5 and 100 bar and at a temperature of between 20° C. and 100° C.

The exact operating conditions depend on the nature of the substrate that needs to be hydrogenated. However, in the general case, a pressure of from 20 to 80 bar and preferably from 40 to 60 bar, and a temperature of from 30 to 70° C. are particularly suitable.

The reaction medium may consist of the reaction medium in which the catalyst was obtained. The hydrogenation reaction is then performed in situ.

As a variant, the catalyst is isolated from the reaction medium in which it was obtained. In this case, the reaction medium of the hydrogenation reaction consists of one or more solvents, chosen especially from C₁-C₅ aliphatic alcohols, such as methanol or propanol, and an amide as defined above, preferably dimethylformamide, optionally as a mixture with benzene.

When the hydrogenation reaction is performed in situ, it is desirable to add to the reaction medium one or more solvents chosen from those mentioned above and more particularly one or more aliphatic alcohols.

According to one preferred embodiment, fully degassed methanol and the substrate are added to the reaction medium containing the complex. The amount of methanol, or more generally of solvent, that may be added is such that the concentration of the substrate in the hydrogenation reaction medium is between 1×10³ and 10 mol/l and preferably between 0.01 and 1 mol/l.

The molar ratio of the substrate to the catalyst generally ranges from 1/100 to 1/100 000 and preferably from 1/20 to 1/2000. This ratio is, for example, 1/1000.

The removal of the catalyst from the reaction medium is facilitated when the ligand used is in the form of a polymer.

The catalyst is separated from the reaction medium by nanofiltration or ultrafiltration.

The technique of nanofiltration is more particularly suitable in the case of catalysts of polymer type. The application of this technique is illustrated, for example, in Tetrahedron: Asymmetry, Vol. 8, No 12, 1975-1977, 1997.

One advantage of the process of the invention is that the recovered catalyst may be readily recycled without loss of activity.

The ruthenium, rhodium and iridium complexes prepared using the ligands of the invention are more especially suitable for the asymmetric catalysis of asymmetric hydrogenation reactions.

The ruthenium complexes prepared using the ligands of the invention are more especially suitable for the asymmetric catalysis of hydrogenation reactions of C═O bonds, C═N bonds and C═C bonds and preferably C═C bonds of α,β-ethylenic carboxylic acids.

As regards the hydrogenation of double bonds, the suitable substrates are of α,β-unsaturated carboxylic acid type and/or derivatives of α,β-unsaturated carboxylic acids. These substrates are described in EP 95943260.0.

The α,β-unsaturated carboxylic acid and/or the derivative thereof more particularly corresponds to formula A: 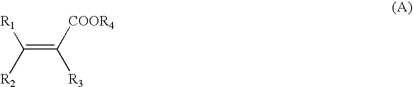
in which:
   R₁, R₂, R₃ and R₄ represent a hydrogen atom or any hydrocarbon-based group, insofar as:
      if R₁ is different than R₂ and different than a hydrogen atom, then R₃ may be any hydrocarbon-based group or functional group denoted by R,
      if R₁ or R₂ represents a hydrogen atom and if R₁ is different than R₂, then R₃ is different than a hydrogen atom and different than —COOR₄,
      if R₁ is identical to R₂ and represents any hydrocarbon-based group or functional group denoted by R, then R₃ is different than —CH—(R)₂ and different than —COOR₄
   one of the groups R₁, R₂ and R₃ possibly representing a functional group.

A specific example that may be mentioned, inter alia, is 2-methyl-2-butenoic acid.

A first group of preferred substrates is formed by the substituted acrylic acids that are precursors of amino acids and/or derivatives.

The term “substituted acrylic acids” means the set of compounds whose formula is derived from that of acrylic acid by substitution of at least two of the hydrogen atoms borne by the ethylenic carbon atoms with a hydrocarbon-based group or with a functional group.

They may be symbolized by the following chemical formula: 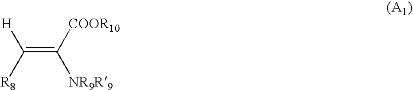
in which:
   R₉ and R′₉, which may be identical or different, represent a hydrogen atom, a linear or branched alkyl group containing from 1 to 12 carbon atoms, a phenyl group or an acyl group containing from 2 to 12 carbon atoms, preferably an acetyl or benzoyl group,
   R₈ represents a hydrogen atom, an alkyl group containing from 1 to 12 carbon atoms, a cycloalkyl group containing from 3 to 8 carbon atoms, an arylalkyl group containing from 6 to 12 carbon atoms, an aryl group containing from 6 to 12 carbon atoms or a heterocyclic group containing from 4 to 7 carbon atoms,
   R₁₀ represents a hydrogen atom or a linear or branched alkyl group containing from 1 to 4 carbon atoms.

Mention may be made more particularly of:
methyl α-acetamidocinnamate,
methyl acetamidoacrylate,
benzamidocinnamic acid,
α-acetamidocinnamic acid.

A second preferred group of substrates consists of itaconic acid and derivatives thereof of formula: 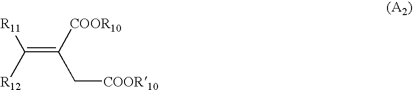
in which:
R₁₁ and R₁₂, which may be identical or different, represent a hydrogen atom, a linear or branched alkyl group containing from 1 to 12 carbon atoms, a cycloalkyl group containing from 3 to 8 carbon atoms, an arylalkyl group containing from 6 to 12 carbon atoms, an aryl group containing from 6 to 12 carbon atoms or a heterocyclic group containing from 4 to 7 carbon atoms,
R₁₀ and R′₁₀, which may be identical or different, represent a hydrogen atom or a linear or branched alkyl group containing from 1 to 4 carbon atoms.

More particular examples that may especially be mentioned include itaconic acid and dimethyl itaconate.

A third preferred group of substrates is defined by formula (A₃): 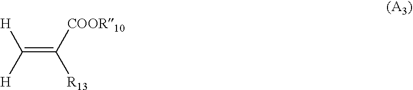
in which:
   R″₁₀ represents a hydrogen atom or a linear or branched alkyl group containing from 1 to 4 carbon atoms,
   R₁₃ represents a phenyl or naphthyl group optionally bearing one or more substituents.

Specific examples that may be mentioned include the substrates leading via hydrogenation to 2-(3-benzoylphenyl)propionic acid (Ketoprofen®), 2-(4-isobutylphenyl)propionic acid (Ibuprofen®) and 2-(5-methoxynaphthyl)propionic acid (Naproxen®).

As regards the hydrogenation of carbonyl bonds, the ruthenium complexes are more particularly suitable for the asymmetric catalysis of hydrogenation reactions of the C═O bonds of β-keto esters, of α-keto esters or of ketones.

The appropriate substrates of ketone type more preferably correspond to formula (B): 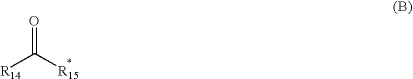
in which:
   R₁₄ is different than R₁₅,
   R₁₄ and R₁₅ represent a hydrocarbon-based group containing from 1 to 30 carbon atoms optionally comprising one or more functional groups,
   R₁₄ and R₁₅ may form a ring optionally comprising another hetero atom.

These compounds are described specifically in FR 96/08060 and EP 97930607.3.

One preferred group of ketone compounds corresponds to formula (B) in which R₁₄ and R₁₅ represent, independently of each other:
an alkyl chain, preferably of C₁ to C₁₀, optionally interrupted with one or more oxygen or sulfur atom(s) or carbonyl function(s) and optionally substituted with one or more halogen atoms or carboxyl groups,
an alkenyl or alkynyl chain, preferably of C₂ to C₁₀, optionally interrupted with one or more oxygen or sulfur atom(s) or carbonyl function(s) and optionally substituted with one or more halogen atom(s) or carboxyl group(s);
an aryl group, preferably of C₆ to C₁₂, optionally substituted with one or more halogen atom(s) or alkyl or alkenyl group(s);
an arylalkyl group, preferably of C₇ to C₁₅, optionally substituted with one or more halogen atoms;
an arylalkenyl group, preferably of C₈ to C₁₅, optionally substituted with one or more halogen atoms; and
* indicates the optional presence in R₁₅ of an asymmetric center located in the position a to the carbonyl function.

By way of representation of the substituents R₁₅ containing an asymmetric center, mention may be made particularly of groups R₁₅ in which the carbon atom bearing the asymmetric center is substituted with a mono- or disubstituted amine function and with an ester function.

According to one particularly preferred embodiment of the invention, the substrate is a β-keto ester (such as ethyl acetoacetate or methyl 3-oxovalerate), an α-keto ester (such as methyl benzoylformate or methyl pyruvate), a ketone (such as acetophenone) or an α,β-ethylenic carboxylic acid (such as itaconic acid) or an unsaturated amino acid or a derivative thereof (such as methyl 2-acetamidoacrylate).

The invention moreover relates to the use of a combination of a chiral diphosphine or of an optically active polymer according to the invention with a chiral or achiral diamine, for the selective reduction of ketones.

Advantageously, a chiral diamine is used in this combination.

The diamines that may be used for this purpose are the optically active diamines described in WO 97/20789 and the corresponding racemic diamines.

According to one particularly preferred embodiment of the invention, the diamine is 1,2-diamino-1,2-diphenylethane; 1,1-bis(p-methoxyphenyl)-2-methyl-1,2-diaminoethane; 1,1-bis(p-methoxyphenyl)-2-isobutyl-1,2-diaminoethane; or 1,1-bis(p-methoxyphenyl)-2-isopropyl-1,2-diaminoethane.

Examples of chiral diamines are more particularly those of formula: 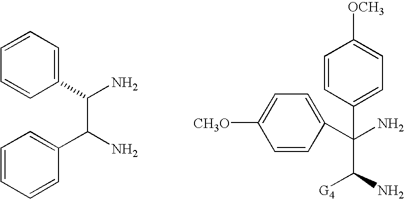
in which G₄ is alkyl, for example methyl, isobutyl or isopropyl.

Mention will be made more particularly of the achiral ethylenediamine and of achiral or chiral 1,2-diamino-1,2-diphenylethane, such as R,R-1,2-diamino-1,2-diphenylethane.

The ketones that may be reduced according to this process are those described above.

The conditions for performing the reduction are those generally described above.

The invention also relates to the use of the combination of an achiral diphosphine or of a racemic polymer, according to the invention, with a chiral diamine, for the selective reduction of ketones.

The chiral diamine that may be used is as described in WO 97/20789, the ketones and the operating conditions being as defined above.

The rhodium complexes prepared from the ligands of the invention are more especially suitable for the asymmetric catalysis of olefin isomerization reactions.

The use of a ligand of formula (Ia₃) or polymers derived therefrom such as polyurea, polyamide or polyimine intended for the asymmetric catalysis of hydrogenation reactions, forms a preferred subject of the invention.

The examples that follow more specifically illustrate the invention.

The meaning of the abbreviations used is given below.

| Ligand name | Formula |
|---|---|
| BINAPO | 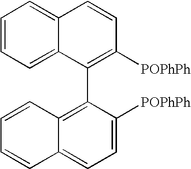 |
| 5,5′-dibromoBINAPO | 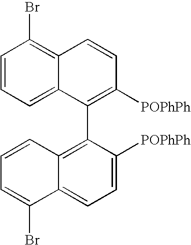 |
| 5,5′-dicyanoBINAPO | 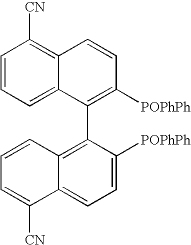 |
| 5,5′-dicyanoBINAP | 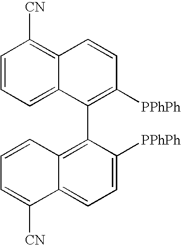 |
| 5,5′-diaminomethylBINAP “5,5′-diamBINAP” | 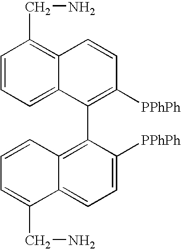 |

The examples that follow illustrate the invention more specifically.

### EXAMPLE 1

Preparation of 5,5′-dibromoBINAPO:

Preparation of BINAPO:

(S)- or (R)-BINAP (2,2′-bis(diphenylphosphino)-1,1′-binaphthyl) (3 g, 4.81 mmol, 1 eq.) dissolved in 100 mL of CH₂Cl₂ is placed in a 250 mL round-bottomed flask.

The mixture is cooled to 0° C. and 10 mL of 35% by weight aqueous hydrogen peroxide solution are added.

The mixture is stirred while being allowed to return to room temperature, for four hours.

100 mL of water are then added.

The organic phase is separated out and the aqueous phase is extracted with CH₂Cl₂.

The combined organic phases are washed with saturated sodium bisulfite.

The solution is checked for the absence of peroxide, and is then dried over sodium sulfate and evaporated.

A white solid is obtained (m=3.14 g, 4.8 mmol, i.e. quantitative yield).

The characterization of the diphosphine in dioxide form (BINAPO) is as follows:

¹H NMR (300 MHz, CDCl₃): 6.80 (d, 4H, J=3.7), 7.2-7.3 (m, 8H), 7.3-7.5 (m, 12H), 7.6-7.7 (m, 4H), 7.8-7.9 (m, 4H)

³¹P NMR (81 MHz, CDCl₃): 28.67

melting point: 256-258° C.

Preparation of 5,5-dibromoBINAPO:

Iron filings (622 mg, 11.1 mmol, 1.5 eq.), 65 mL of CCl₄ and dibromine (7.6 mL, 148 mmol, 20 eq.) are placed in a dry 100 mL round-bottomed flask equipped with a condenser and a CaCl₂ guard tube.

The mixture is heated to 70° C., followed by portionwise addition of BINAPO (4.8 g, 7.4 mmol, 1 eq.) dissolved in 45 mL of CCl₄.

The mixture is stirred at 70° C. for 3 hours.

After checking by thin layer chromatography that the reaction is complete, the mixture is transferred into a separating funnel and washed with water, with sodium bisulfite, with sodium bicarbonate and then with brine.

The resulting solution is dried over sodium sulfate and then filtered through silica and eluted with ethyl acetate.

The solution thus obtained is evaporated under reduced pressure (about 8 mmHg).

A white solid is obtained (m=4.85 g, 6 mmol, i.e. a yield of 80.7%).

The characterization of the diphosphine (PO) in dibromo form is as follows:

¹H NMR (200 MHz, CDCl₃): 6.62 (t, 2H, J=15.0), 6.72 (d, 2H, J=9.0), 7.2-7.5 (m, 22H), 7.55 (dd, 2H, J=3.0; 21.0), 7.6-7.8 (m, 4H), 8.3 (dd, 2H, J=1.7; 9.0)

³¹P NMR (81 MHz, CDCl₃): 29.20

melting point >300° C.

### EXAMPLE 2

Preparation of 5,5′-dicyanoBINAPO:

5,5′-DibromoBINAPO (4.7 g, 5.8 mmol, 1 eq.) and copper cyanide (1.04 g, 16.24 mmol, 2.8 eq.) are placed in a 250 mL round-bottomed flask under an inert atmosphere, equipped with a condenser.

The mixture is dissolved in 70 mL of DMF and is refluxed overnight.

The mixture is cooled and then treated with a solution of ethylenediamine (25 mL) and water (25 mL).

The mixture is stirred for 2 minutes, and 100 mL of water and 200 mL of toluene are then added.

The mixture is stirred for 5 minutes and the aqueous phase is then extracted once with toluene.

The combined organic phases are successively washed once with water, four times with HCl, once with brine and then once with sodium bicarbonate.

The product is then dried over sodium sulfate, and then evaporated under reduced pressure (about 8 mmHg) (m=3.71 g, 5.5 mmol, i.e. a yield of 90.8%).

The product is purified on a column of silica gel, eluting with ethyl acetate/cyclohexane (4/6).

2.52 g (3.75 mmol, i.e. a yield of 61.7%) of pure white product are obtained.

The characterization of the diphosphine (PO) in dicyano form is as follows:

¹H NMR (200 MHz, CDCl₃): 6.85 (dd, 2H, J=7.0; 7.1), 6.97 (d, 2H, J=9.0), 7.2-7.5 (m, 24H), 7.6-7.7 (m, 6H), 7.8 (dd, 2H, J=1.1; 6.1), 8.33 (dd, 2H, J=1.9; 7.1)

³¹P NMR (81 MHz, CDCl₃): 29.1

ESI⁺ mass: MH⁺=705

melting point >300° C.

### EXAMPLE 3

Preparation of 5,5′-dicyanoBINAP:

5,5′-DicyanoBINAPO (420 mg, 0.6 mmol) is placed in a dry 25 mL round-bottomed flask under an inert atmosphere, equipped with a condenser.

Phenylsilane (8 mL, 64.8 mmol) is added and the suspension is degassed under reduced pressure (about 8 mmHg) and argon is introduced.

The mixture is heated to 130° C. and trichlorosilane is added in three portions (3×1 mL) after 1 hour, 3 hours and then 15 hours; the mixture is then stirred for a further 2 hours.

The resulting mixture is cooled and the product is evaporated to give a white solid.

This solid is washed with cyclohexane, filtered on a Millipore filter and then dried under reduced pressure (about 8 mmHg).

Pure (S) or (R) products are obtained in quantitative yields.

The characterization of the diphosphine in dicyano form is as follows:

¹H NMR (300 MHz, CDCl₃): 6.63-6.81 (m, 4H), 7.04-7.30 (m, 20H), 7.42 (d, 2H, J=7.14), 7.56 (d, 2H, J=8.85), 8.33 (d, 2H, J=9.03)

³¹P NMR (81 MHz, CDCl₃): -13.99.

### EXAMPLE 4

Preparation of 5,5′-diaminomethylBINAP:

5,5′-DicyanoBINAP (400 mg, 0.6 mmol) is placed in a 100 mL round-bottomed flask under an argon atmosphere.

The product is dissolved in a (1:1) mixture of 22.5 mL of THF and 22.5 mL of toluene.

LiAlH₄ (227.7 mg, 6 mmol) is then added portionwise.

The mixture is heated at 105° C. for 2 hours.

The resulting mixture is cooled, and 0.5 mL of water and 0.5 mL of sodium hydroxide solution (15% by mass) are then added.

After stirring for three minutes, 1.5 g of Celite are added.

After five minutes, the mixture is then filtered and the residue is washed with dichloromethane.

The filtrate is evaporated and then dried under reduced pressure (about 8 mmHg) to give a yellow-white solid.

The product is obtained in quantitative yield.

The characterization of the diphosphine in diaminomethyl form is as follows:

¹H NMR (200 MHz, CDCl₃): 1.62 (s, 4H), 4.37 (s, 4H), 6.8-7.0 (m, 4H), 7.1-7.3 (m, 20H), 7.36 (d, 2H, J=6.58), 7.51 (d, 2H, J=8.82), 8.15 (d, 2H, J=8.82)

³¹P NMR (81 MHz, CDCl₃): −15.50

¹³C NMR (50 MHz, CDCl₃): 44.30; 122.92; 125.61; 125.93; 127.32; 128.12; 128.30; 128.44; 128.71; 129.02; 129.31; 130.04; 132.57; 132.88; 133.18; 133.81; 135.23; 139.42

α_{D} (c=1, DMF): −100.3 for (S)

α_{D} (c=1, DMF): +101.4 for (R)

### EXAMPLE 5

1—Hydrogenation Test:

The procedure followed is given below.

5,5′-DiamBINAP (17.5 mg, 0.0235 mmol, 1 eq.) dissolved in 1 mL of dichloromethane is placed in a 5 mL vial under an inert atmosphere, bis(2-methylallyl) cycloocta-1,5-dieneruthenium (II) complex (7.5 mg, 0.0235 mmol, 1 eq.) is added and the mixture is stirred for 30 minutes.

The solvent is then evaporated off.

1 ml of methanol (or ethanol) is added and the substrate is then placed in an autoclave under a hydrogen pressure of 40 bar at 50° C. and stirred for 15 hours.

The autoclave is then cooled and depressurized.

The solution is filtered through Celite and then analyzed by gas chromatography.

2—Hydrogenation of Ethyl or Methyl Acetoacetate

This is performed as described above with a substrate/catalyst ratio of 1000.

The results obtained are as follows:

| Substrate | Conversion (%) | e.e.* (%) |
|---|---|---|
| Ethyl acetoacetate | 100 | >99 |
| Methyl acetoacetate | 100 | >99 |

$* ee = \frac{\% ( R ) - \% ( S )}{\% ( R ) + \% ( S )}$

These results are confirmed whether 5,5′-diamBINAP is used in (S) or (R) form.

The configuration of the corresponding alcohol obtained depends on the chirality of the ligand used.

### EXAMPLES 6 AND 7

Preparation of (R)-5,5′-perfluorohexylBINAPo and (R) -5,5′-perfluorooctylBINAPO

5,5′-DibromoBINAPO (2.46 mmol, 1 eq.), copper powder (14.76 mmol, 6 eq.) and the alkyl iodoperfluoride (7.38 mmol, 3 eq.), i.e. hexyl in example 6 and octyl in example 7, are placed in a 250 mL round-bottomed flask under an argon atmosphere.

The mixture is dissolved in 40 mL of DMSO and heated at 80° C. for 3 days.

The mixture is then cooled and 20 mL of water and 40 mL of dichloromethane are then added.

The resulting mixture is filtered and the organic phase is recovered.

This phase is washed with 10 mL of water, 20 mL of hydrochloric acid and 15 mL of sodium bicarbonate.

The solution is dried and evaporated to give 2.33 mmol of a cream-white powder (94.7%).

The characterization of the diphosphine (R)-5,5′-perfluorohexylBINAPO is as follows:

¹H NMR (300 MHz, CDCl₃): 6.73-6.91 (m, 4H), 7.17-7.41 (m, 18H), 7.51 (dd, 2H, J=9.4, 11.7), 7.63-7.72 (m, 4H), 8.27 (d, 2H, J=8.3)

¹³C NMR (75 MHz, CDCl₃): 116.3, 120.2, 124.5, 124.8, 125.3, 126.5, 128.4, 128.5, 128.6, 128.7, 128.9, 129.4, 129.7, 130.1, 130.3, 130.4, 131.1, 131.4, 131.6, 132.1, 132.2, 132.3, 132.7, 132.8, 133.1

³¹P NMR (81 MHz, CDCl₃): 28.33

¹⁹F NMR (282 MHz, CDCl₃): -126.37 (s, 4F), −123.01 (s, 4F), −121.79 (s, 4F), −120.64 (s, 4F), −105.21 (s, 4F), −81.15 (s, 6H)

[α_{D}]²⁵: +72.1 (c=1, DMF)

ESI⁺: MH⁺=1291.24

melting point: >300° C. Calcd C 52.11, H 2.34, F 38.27; found C 52.02, H 2.47, F 38.45

The characterization of the diphosphine (R)-5,5′-perfluorooctylBINAPO is as follows:

¹H NMR (300 MHz, CDCl₃): 6.75-6.96 (m, 4H), 7.19-7.40 (m, 18H), 7.56 (dd, 2H, J=9.4, 11.7), 7.65-7.73 (m, 4H), 8.28 (d, 2H, J=8.6)

¹³C NMR (75 MHz, CDCl₃): 124.5, 124.9, 125.2, 126.7, 128.4, 128.5, 128.6, 128.7, 128.8, 129.3, 129.7, 130.1, 130.2, 130.4, 130.9, 131.5, 131.6, 132.0, 132.2, 132.3, 132.7, 132.8, 130.9

³¹P NMR (81 MHz, CDCl₃): 28.58

¹⁹F NMR (282 MHz, CDCl₃): −126.54 (s, 4F), −123.09 (s, 4F), −122.26 (s, 8F), −121.64 (s, 4F), −120.19 (s, 4F), −104.35 (s, 4F), −81.18 (s, 6F)

[α_{D}]²⁵: +73.4 (c=1, DMF)

ESI⁺: MH⁺=1491.54

melting point: >300° C. Calcd C 48.34, H 2.03, F 43.33; found C 48.91, H 1.88, F 43.67

### EXAMPLES 8 AND 9

Preparation of (R)-5,5′-perfluorohexylBINAP and (R)-5,5′-perfluorooctylBINAP

(R)-5,5′-PerfluoroalkylBINAPO (0.6 mmol, 1 eq.) is placed in a 25 mL round-bottomed flask under an inert atmosphere.

Degassed phenylsilane (8 mL) is added. The mixture is heated to 130° C. and trichlorosilane is added in three portions (3×1 mL) after 1, 3 and 15 hours.

After the last addition, the solution is stirred for a further 2 hours and then cooled and evaporated until a white solid is obtained.

This residue is washed with cyclohexane (5 mL), filtered through a Millipore filter and the remaining solvent is then evaporated off to give a white crystalline solid in a yield of 95%.

The characterization of the diphosphine (R)-5,5′ perfluorohexylBINAP is as follows:

¹H NMR (200 MHz, CDCl₃): 6.78-6.98 (m, 4H), 7.13-7.47 (m, 18H), 7.50-7.61 (m, 2H), 7.65-7.78 (m, 4H), 8.29 (d, 2H, J=7.3)

¹³C NMR (75 MHz, CDCl₃): 123.1, 123.3, 124.5, 124.6, 124.8, 125.6, 126.5, 127.1, 127.3, 128.1, 128.2, 128.4, 128.5, 128.7, 130.0, 131.4, 131.8, 132.1, 132.2, 132.4, 132.8, 132.9, 133.2, 133.4, 133.6, 134.4, 134.5, 135.0, 135.4, 135.7, 138.1, 138.4, 143.9, 144.2, 144.7, 145.1

³¹P NMR (81 MHz, CDCl₃): −13.27

¹⁹F NMR (282 MHz, CDCl₃): −126.37 (s, 4F), −123.01 (s, 4F), −121.79 (s, 4F), −120.64 (s, 4F), −105.21 (s, 4F) −81.15 (s, 6H)

[α_{D}]²⁵+35.7 (c=1, DCM)

melting point: >300° C.

HRLSIMS: MH⁺ calc. 1259, 1408, found 1259, 1398

The characterization of the diphosphine (R)-5,5′-perfluorooctylBINAPO is as follows:

¹H NMR (300 MHz, CDCl₃): 6.77-6.96 (m, 4H), 7.02-7.10 (m, 4H), 7.26-7.42 (m, 14H), 7.55-7.61 (m, 6H), 8.29 (d, 2H, J=8.9)

¹³C NMR (75 MHz, CDCl₃): 124.4, 125.4, 126.6, 128.3, 128.4, 128.4, 128.5, 128.6, 128.6, 128.7, 128.8, 128.8, 128.9, 129.3, 129.5, 130.8, 132.0, 132.2, 133.0, 133.2, 133.3, 133.4, 133.6, 133.7, 134.4, 134.5, 134.9, 135.2, 135.4, 135.8, 137.0, 137.4, 137.5, 138.2, 144.0, 144.3, 144.6

³¹P NMR (81 MHz, CDCl₃): −13.18

¹⁹F NMR (282 MHz, CDCl₃): -126.59 (s, 4F), −123.17 (s, 4F), −122.29 (s, 8F), −121.72 (s, 4F), −120.35 (s, 4F), −104.46 (s, 4F), −81.27 (s, 6H)

[α_{D}]²⁵: +35.5 (c=1, DCM)

melting point: >300° C.

HRLSIMS: MH⁺ calc. 1459, 1280, found 1459, 1271

### EXAMPLES 10 AND 11

Hydrogenation Test

In order to evaluate the activities of these novel ligands and the influence of the perfluoro chains, the corresponding metal complexes were prepared by reaction with [RuCl₂(benzene)]₂ in accordance with the general procedure described by Noyori et al. [Kitamura, M.; Tokunaga, M.; Ohkuma, T.; Noyori, R. Tetrahedron Lett. 1991, 32, 4163].

The complexes were tested for the catalytic hydrogenation of several β-keto esters.

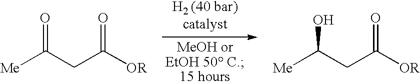

The results are given in the following table:

| | | | | Substrate/ | | |
|---|---|---|---|---|---|---|
| Ex. | | | | catalyst | Conversion | e.e. |
| ref. | Ligand | Complex | R | in mol | (%) | (%) |
| 10 | ex 8 | [RuCl₂(benzene)]₂ | Me | 1000 | 100 | 99 |
| 11 | ex 8 | [RuCl₂(benzene)]₂ | Et | 2000 | 100 | 99 |

### EXAMPLE 12

Preparation of a Polyurea Starting with (S)-5,5′-diaminomethylBINAP (diamBINAP)

The starting diamBINAP (200 mg, 0.29 mmol) prepared according to the procedure described in examples 1 to 4 is placed in a 10 mL round-bottomed flask.

This material is dissolved in 2 mL of degassed anhydrous dichloromethane.

2,6-Diisocyanatotoluene (51 mg, 0.29 mmol) is added under argon.

The solution is stirred for 12 hours and 2 mL of degassed isopropanol are then added.

The solid is filtered off and then washed with isopropanol.

240 mg of polymer (yellow powder) are obtained, i.e. a yield of 96%.

The characterization of the 5,5′-polyNAP obtained is as follows:

[α_{D}]=−103° (c=0.356, DMF)

¹H NMR (DMSO, 200 MHz): 1.03 (d, CH₃); 1.22 (d, CH₃); 2.03 (m, CH₃ tolyl); 3.34 (s, CH₂); 6.67 (d, CH); 6.70-7.50 (m); 7.73 (s, CH); 8.25 (d, CH).

³¹P NMR (DMSO, 81 MHz): −16.53.

### EXAMPLE 13

Preparation of a Ruthenium Catalyst Starting with the Polymer Prepared in Example 12

The polymer and the metallic precatalyst bis(2-methylallyl)cycloocta-1,5-dieneruthenium are weighed out, in a 1:1 polymer/metal molar ratio, in a dry 5 mL glass conical reactor maintained under an inert atmosphere and equipped with a stirrer.

2 mL of degassed anhydrous acetone are added and the suspension is stirred for 30 minutes.

A 48% by weight solution of hydrobromic acid is then added in an Ru/Br ratio of 1/2.3.

The solution then turns dark orange.

The solution is stirred for 1 hour and then evaporated.

The catalyst is then obtained in the form of a brown solid.

### EXAMPLE 14

Hydrogenation of Ethyl Acetoacetate Using the Catalyst Prepared in Example 13

Degassed anhydrous ethanol is added to the reactor in which the catalyst has just been prepared.

The substrate is then added (in a defined catalyst/substrate ratio).

The reactor is placed in an autoclave under a hydrogen pressure of 40 bar and at 50° C.

Stirring is maintained overnight.

The reactor is recovered and then centrifuged.

The supernatant solution is recovered and then analyzed by gas chromatography.

The determination of the enantiomeric excess is performed by chiral gas chromatography on a Lipodex A 25 m×0.25 mm column.

The results obtained are given in the following table:

| Catalyst | Substrate/catalyst | Conversion | e.e. |
|---|---|---|---|
| (5,5′-polyNAP) | in mol | (%) | (%) |
| 5,5′ | 1000 | 100 | 83 |
| 5,5′ | 500 | 100 | 85 |
| 5,5′ (recycled) | 500 | 100 | 90 |

The hydrogenation of ethyl acetoacetate leads to ethyl 3-hydroxybutyrate.

### EXAMPLE 14

Hydrogenation of 2-methylacetamidoacrylate Using the Catalyst Prepared in Example 13

Degassed anhydrous ethanol is added to the reactor in which the catalyst has just been prepared.

The substrate is then added (in a defined catalyst/substrate ratio).

The reactor is placed in an autoclave under a hydrogen pressure of 40 bar and at 50° C.

Stirring is maintained for 6 hours.

The reactor is recovered and then centrifuged.

The supernatant solution is recovered and then analyzed by gas chromatography.

The determination of the enantiomeric excess is performed by chiral gas chromatography on a βdex A 60 m×0.25 mm column.

The results obtained are given in the following table:

| Catalyst | Substrate/catalyst | Conversion | e.e. |
|---|---|---|---|
| (5,5′-polyNAP) | in mol | (%) | (%) |
| 5,5′ | 300 | 100 | 70 |

1-64. (canceled)

65. A diphosphine in racemic form or in chiral form, corresponding to formula (I): 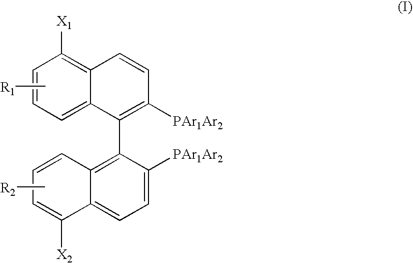
in said formula:
R₁ and R₂, which are identical or different, represent a hydrogen atom or a substituent,
Ar₁ and Ar₂ independently represent an alkyl, alkenyl, cycloalkyl, aryl or arylalkyl group,
X₁ and X₂, which are identical or different, represent:
a group R, alkyl, alkenyl, alkynyl, cycloalkyl, aryl or arylalkyl,
an alkyl group substituted with one or more halogen atoms, preferably fluorine, or with nitro or amino groups,
a halogen atom chosen from bromine, chlorine and iodine,
an —OH group,
a group —O—CORₐ,
a group —O—Rₐ,
a group —S—Rₐ,
a —CN group,
a group derived from the nitrile group such as:
a —CH₂—NH₂ group,
a —COOH group,
a group derived from the carboxylic group such as:
a group —COORₐ,
a —CH₂OH group,
a group —CO—NH—R_{b},
a group derived from the aminomethyl group such as:
a group —CH₂—NH—CO—R_{b},
a group —CH₂—NH—CO—NH—R_{b},
a group —CH₂—N═CH—Rₐ,
a —CH₂—N═C═O group,
a —CH₂—NH₄⁺ group,
a group comprising a nitrogen atom such as:
a group —NHRₐ,
a group —N(Rₐ)₂,
a group —N═CH—Rₐ,
an —NH—NH₂ group,
an —N═N+═N⁻ group,
an —N═C═O group, or
a magnesium or lithium atom,
in the various formulae, Rₐ represents an alkyl, cycloalkyl, arylalkyl or phenyl group and R_{b} has the meaning given for Rₐ and also represents a naphthyl group.

66. The diphosphine as claimed in claim 65, bearing two functional groups capable of reacting with one or more polymerizable monomers corresponding to the general formula (I′): 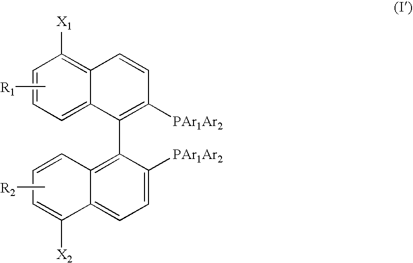
in said formula:
R₁ and R₂, which are identical or different, represent a hydrogen atom or a substituent,
Ar₁ and Ar₂ independently represent an alkyl, alkenyl, cycloalkyl, aryl or arylalkyl group,
X₁ and X₂, which are identical, represent:
an —OH group,
a —CH₂OH group,
a —CH₂—NH₂,
a —COOH group,
a group —COORₐ in which Rₐ represents an alkyl, cycloalkyl, arylalkyl or phenyl group,
an —N═C═O group, or
a —CH₂—N═C═O group.

67. The diphosphine as claimed in claim 65, wherein in formula (I) or (I′) Ar₁ and Ar₂ represent a (C₁-C₆)alkyl group, a phenyl group optionally substituted with one or more (C₁-C₆)alkyl or (C₁-C₆)alkoxy; or a (C₄-C₈)cycloalkyl group optionally substituted with one or more (C₁-C₆)alkyl groups.

68. The diphosphine as claimed in claim 65, wherein in formula (I) or (I′) R₁ and R₂, which are identical or different, represent a hydrogen atom or an alkyl or alkoxy group containing from 1 to 4 carbon atoms, Ar₁ and Ar₂ represent a phenyl group and R₁ and R₂ represent a hydrogen atom, and X₁ and X₂, which are identical, represent:
a halogen atom, preferably a bromine or chlorine atom,
an alkyl group substituted with one or more fluorine atoms,
a —CN group,
a —CH₂—NH₂ group, or
a —COOH group.

69. A diphosphine in dioxide form, in racemic form or in chiral form corresponding to formula (II): 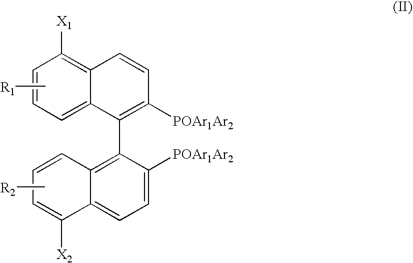
in which in said formula:
R₁ and R₂, which are identical or different, represent a hydrogen atom or a substituent,
Ar₁ and Ar₂ independently represent an alkyl, alkenyl, cycloalkyl, aryl or arylalkyl group,
X₁ and X₂, which are identical or different, represent:
a group R, alkyl, alkenyl, alkynyl, cycloalkyl, aryl or arylalkyl,
an alkyl group substituted with one or more halogen atoms, preferably fluorine, or with nitro or amino groups,
a halogen atom chosen from bromine, chlorine and iodine,
an —OH group,
a group —O—CORₐ,
a group —O—Rₐ,
a group —S—Rₐ,
a —CN group,
a group derived from the nitrile group such as:
a —CH₂—NH₂ group,
a —COOH group,
a group derived from the carboxylic group such as:
a group —COORₐ,
a —CH₂OH group,
a group —CO—NH—R_{b},
a group derived from the aminomethyl group such as:
a group —CH₂—NH—CO—R_{b},
a group —CH₂—NH—CO—NH—R_{b},
a group —CH₂—N═CH—Rₐ,
a —CH₂—N═C═O group,
a —CH₂—NH₄⁺ group,
a group comprising a nitrogen atom such as:
a group —NHRₐ,
a group —N(Rₐ)₂,
a group —N═CH—Rₐ,
an —NH—NH₂ group,
an —N═N⁺═N⁻ group,
an —N═C═O group, or
a magnesium or lithium atom,
in the various formulae, Rₐ represents an alkyl, cycloalkyl, arylalkyl or phenyl group and R_{b} has the meaning given for Rₐ and also represents a naphthyl group.

70. The diphosphine or diphosphine in dioxide form as claimed in claim 69, wherein it corresponds to one of the following formulae:

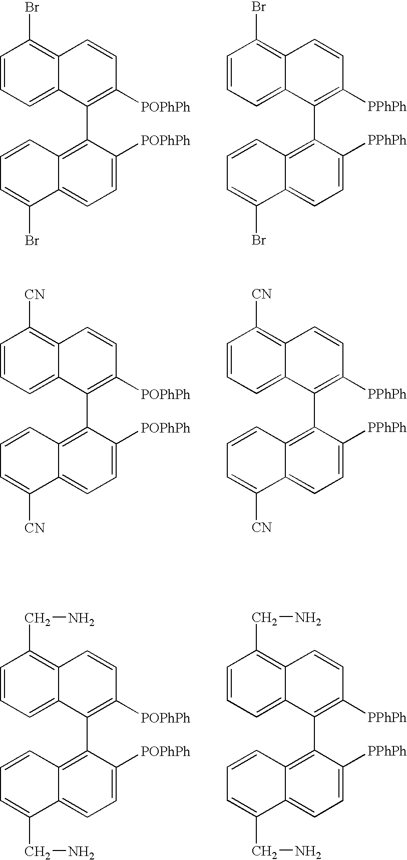

71. The diphosphine or diphosphine in dioxide form as claimed in claim 65 having one of the following formulae: 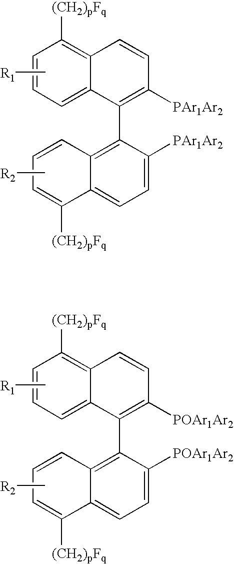
in which p is between 1 and 15, optionally between 6 and 10, q is between 3 and 21, optionally between 13 and 25.

72. A process for preparing a diphosphine or a diphosphine in dioxide form as defined in claim 65, comprising at least one step of halogenation in position 5,5′ of
a compound of formula (III): 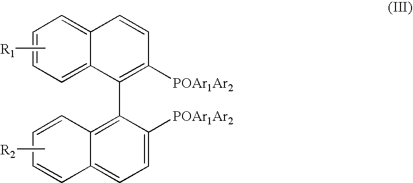
in said formula R₁, R₂, Ar₁ and Ar₂ have the meaning given above, said halogenation being optionally performed in an inert aprotic solvent.

73. The process as claimed in claim 72, wherein the diphosphine in dioxide form of formula (III) is obtained by oxidation of the chiral or achiral diphosphine of
formula (IV): 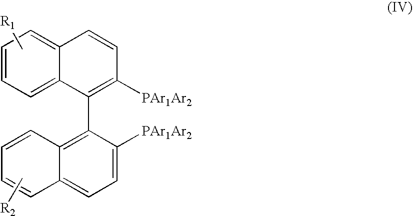
in said formula:
R₁, R₂, Ar₁ and Ar₂ having the meaning given above.

74. A process for preparing the diphosphine corresponding to formula (I) or (I′) as defined in claim 65, and wherein X₁ and X₂ represent a halogen atom, said process comprising the following steps:
i) performing an halogenation in the 5,5′ position of a compound of formula (III): 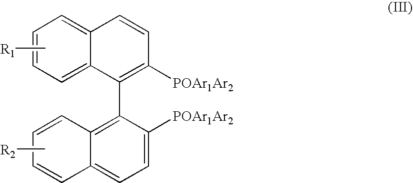
wherein:
R₁, R₂, Ar₁ and Ar₂ have the meaning given above,
using a halogen and in the presence of iron, so as to obtain the corresponding dihalo
compound of formula: 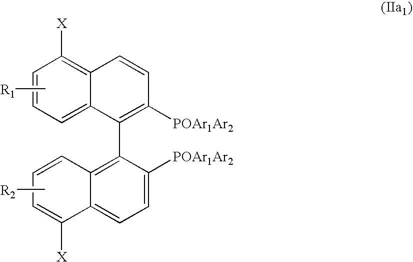
in said formula:
X represents a chlorine, bromine or iodine atom,
R₁, R₂, Ar₁ and Ar₂ have the meaning given above; and
ii) performing the reduction of the diphosphine in dioxide and dihalo form in position 5,5′ of formula (IIa₁), into the diphosphine of formula (Ia₁): 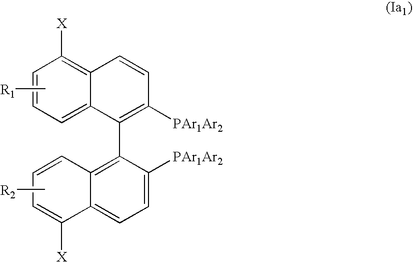
in said formula:
X represents a chlorine, bromine or iodine atom, and
R₁, R₂, Ar₁ and Ar₂ having the meaning given above.

75. A process for preparing the diphosphine corresponding to formula (I) or (I′) as defined in claim 65 and wherein X₁ and X₂ represent a —CN group, comprising the following steps:
i) performing a cyanation by the substitution of the two halogen atoms, optionally in the presence of copper cyanide, with cyano groups by reacting the diphosphine in dioxide and dihalo form in position 5,5′ of formula (IIa₁): 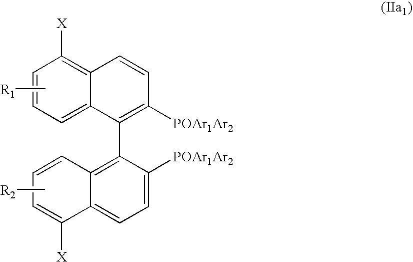
in said formula:
X represents a chlorine, bromine or iodine atom,
R₁, R₂, Ar₁ and Ar₂ have the meaning given above,
using a suitable nucleophilic reagent so as to obtain the corresponding dicyano compound (IIa₂): 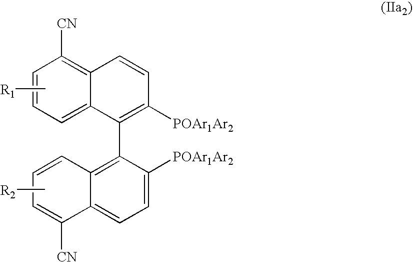
in said formula:
R₁, R₂, Ar₁ and Ar₂ have the meaning given above, and
ii) performing the reduction of the diphosphine in dioxide and dicyano form in position 5,5′ of formula (IIa₂) into the diphosphine of formula (Ia₂): 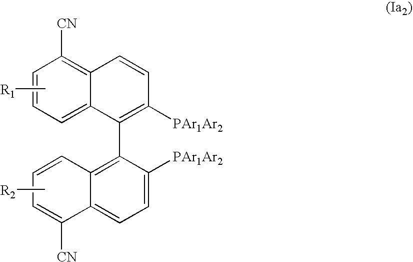
in said formula:
R₁, R₂, Ar₁ and Ar₂ have the meaning given above.

76. The process as claimed claim 75, wherein the reduction of the diphosphine in dioxide form is performed using a hydrogenosilane of formula:
HSiR_{α}R_{β}R_{δ} (Fₐ)
in said formula:
R_{α}, R_{β} and R_{δ}, which are identical or different, represent a hydrogen atom, an alkyl group containing from 1 to 6 carbon atoms, a phenyl group or a chlorine atom, and
at most two of the groups R_{α}, R_{β} and R_{δ} represent a hydrogen atom, and optionally using a mixture of PhSiH₃ (or PMHS) and HSiCl₃.

77. A process for preparing the diphosphine as defined in claim 65, wherein X₁ and X₂ represent a —CH₂—NH₂ group, said process comprising a step of reducing, optionally in the presence of lithium aluminum hydride (LiAlH₄), the cyano group of the compound of formula (Ia₂) 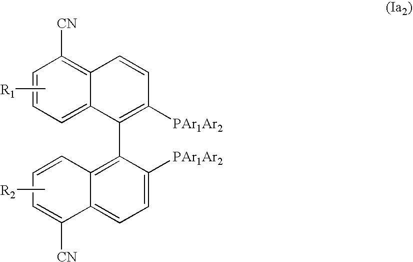
in said formula:
R₁, R₂, Ar₁ and Ar₂ have the meaning given above,
leading to the corresponding diaminomethyl compound of formula (Ia₃): 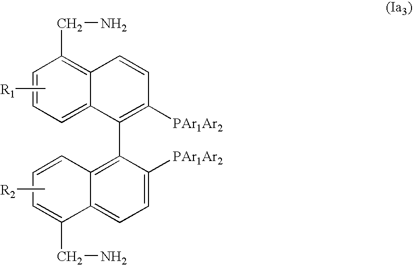
in said formula:
R₁, R₂, Ar₁ and Ar₂ have the meaning given above.

78. The process for preparing the diphosphine as defined in claim 65, wherein X₁ and X₂ represent a —COOH group comprising the steps of:
i) performing a cyanation by the substitution of the two halogen atoms, optionally in the presence of copper cyanide, with cyano groups by reacting the diphosphine in dioxide and dihalo form in position 5,5′ of formula (IIa₁): 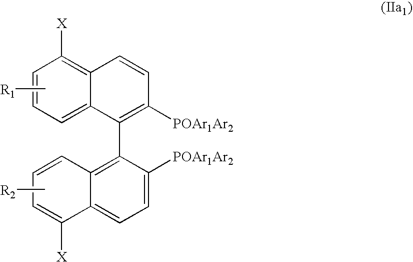
in said formula:
X represents a chlorine, bromine or iodine atom,
R₁, R₂, Ar₁ and Ar₂ have the meaning given above,
using a suitable nucleophilic reagent so as to obtain the corresponding dicyano compound (IIa₂): 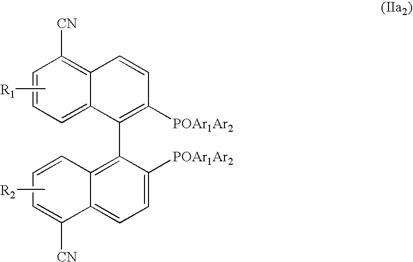
in said formula:
R₁, R₂, Ar₁ and Ar₂ have the meaning given above, and
ii) performing the reduction of the diphosphine in dioxide and dicyano form in position 5,5′ of formula (IIa₂) into the diphosphine of formula (Ia₂): 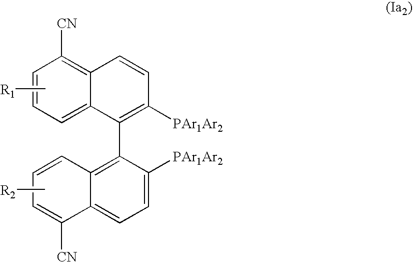
in said formula:
R₁, R₂, Ar₁ and Ar₂ have the meaning given above; and, then,
iii) treating, in acidic medium or in basic medium, the compound of formula (Ia₂), so as to obtain the corresponding carboxylic acid of formula (Ia₄): 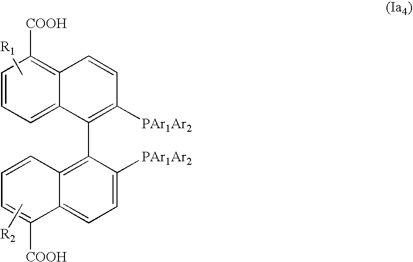
in said formula:
R₁, R₂, Ar₁ and Ar₂ have the meaning given above.

79. The process for preparing the diphosphine as defined in claim 65,
wherein X₁ and X₂ represent a group —COORₐ in which Rₐ represents an alkyl, cycloalkyl, arylalkyl or phenyl group, comprising the step of performing the direct esterification of a compound of formula (Ia₄): 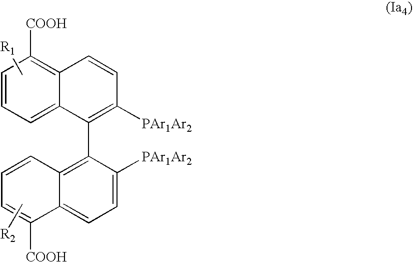
in said formula:
R₁, R₂, Ar₁ and Ar₂ have the meaning given above.

80. A polymer in racemic or optically active form, made by reaction of a chiral or achiral diphosphine of formula (I′) as defined in claim 66, with one or more polymerizable monomers.

81. The polymer as claimed in claim 80, wherein the diphosphine corresponds to formula (Ia₃) as follows: 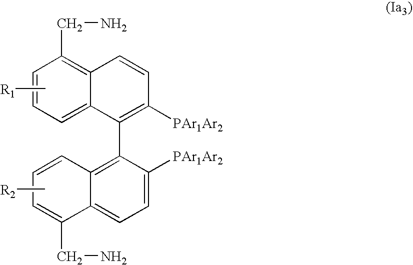
in said formula:
R₁, R₂, Ar₁ and Ar₂ have the meaning given above.

82. The polymer as claimed in claim 80, wherein the monomer reacted with the diphosphine corresponds to formula (X) below:
Y₁-M-Y₁ (X)
in which:
M represents a divalent hydrocarbon-based group of aliphatic, alicyclic and/or aromatic nature, and
Y₁ represents a functional group, optionally a carboxylic, ester, hydroxyl, amino, isocyanato, aldehyde or ketone group.

83. The polymer as claimed in claim 82, wherein the monomer reacted with the diphosphine corresponds to formula (X) in which M represents a C₁-C₁₂ and preferably C₁-C₆ alkylene chain; a cycloalkylene group, preferably cyclohexylene; an arylene group, preferably phenylene, tolylene or naphthalene.

84. A polymer in racemic or optically active form comprising the following repeating unit: 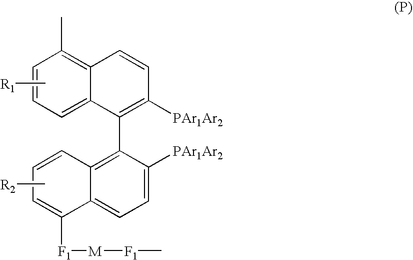
in which
R₁ and R₂, which are identical or different, represent a hydrogen atom or a substituent,
Ar₁ and Ar₂ independently represent an alkyl, alkenyl, cycloalkyl, aryl or arylalkyl group,
M represents a divalent hydrocarbon-based group of aliphatic, alicyclic and/or aromatic nature;
F₁ represents a functional group resulting from the reaction:
of the group X₁ chosen from the following groups: aminomethyl, hydroxyl, hydroxymethyl, carboxylic, ester, isocyanato, isocyanatomethyl,
and of the group Y₁ chosen from carboxylic, ester, hydroxyl, amino, isocyanato, aldehyde and ketone groups, and
the degree of polymerization is optionally between 2 and 100.

85. The polymer as claimed in claim 84, wherein in formula (P), M represents a C₁-C₁₂ and optionally C₁-C₆ alkylene chain; a cycloalkylene group, cyclohexylene; an arylene group, phenylene, tolylene or naphthalene.

86. The polymer as claimed in claim 84, wherein in formula (P), F₁ represents:
a urea group (F₁) resulting from the reaction of an aminomethyl group (X₁) with an isocyanato group (Y₁) or an isocyanato or isocyanatomethyl group (X₁) with an amino group (Y₁),
a urethane group (F₁) resulting from the reaction of an isocyanato or isocyanatomethyl group (X₁) with a hydroxyl group (Y₁) or a hydroxyl or hydroxymethyl group (X₁) with an isocyanato group (Y₁),
an ester group (F₁) resulting from the reaction of a carboxylic or ester group (X₁) with a hydroxyl group (Y₁) or a hydroxyl or hydroxymethyl group (X₁) which a carboxylic or ester group (Y₁),
an amide group (F₁) resulting from the reaction of a carboxylic group (X₁) with an amino group (Y₁) or an aminomethyl group (X₁) with a carboxylic group (Y₁), or
an imine group (F₁) resulting from the reaction of an aminomethyl group (X₁) with an aldehyde or ketone group (Y₁).

87. The polymer as claimed in claim 80, wherein the polymer is a polyurea, polyamide, polyimide, polyimine, polyester or polyurethane.

88. The polymer as claimed in claim 84, wherein it is a polymer of polyurea type containing the repeating unit: 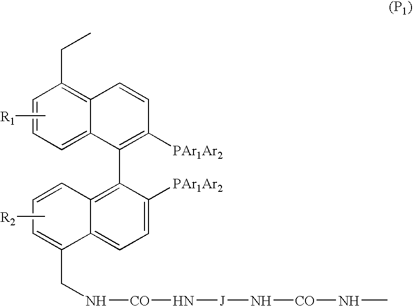
in which:
R₁ and R₂, which are identical or different, represent a hydrogen atom or a substituent,
Ar₁ and Ar₂ independently represent an alkyl, alkenyl, cycloalkyl, aryl or arylalkyl group,
J represents a divalent hydrocarbon-based group of aliphatic, alicyclic and/or aromatic nature, and
the degree of polymerization is optionally between 2 and 100.

89. A process for preparing the polyurea as claimed in claim 88, wherein a diphosphine bearing two —CH₂—NH₂ groups is polymerized with one or more di- or polyisocyanates.

90. The polymer as claimed in claim 80, wherein it is a polyamide containing the repeating unit: 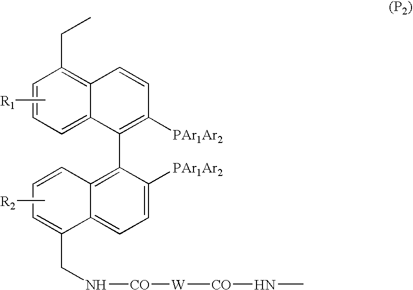
in which:
R₁ and R₂, which are identical or different, represent a hydrogen atom or a substituent,
Ar₁ and Ar₂ independently represent an alkyl, alkenyl, cycloalkyl, aryl or arylalkyl group,
W represents a divalent hydrocarbon-based group of aliphatic, alicyclic and/or aromatic nature,
the degree of polymerization is optionally between 2 and 100.

91. A transition metal complex comprising at least one ligand as defined in claim 65.

92. A transition metal complex comprising at least one ligand as defined in claim 80.

93. The complex as claimed in claim 91, wherein the transition metal is chosen from: rhodium, ruthenium, rhenium, iridium, cobalt, nickel, platinum and palladium.
